(19) United States
(12) Patent Application Publication
(10) Pub. No.: US 2021/0284565 A1
(43) Pub. Date: Sep. 16, 2021

(54) GLASS PANEL WITH REDUCED EXTENSION STRAIN

(71) Applicant: SAINT-GOBAIN GLASS FRANCE, COURBEVOIE (FR)

(72) Inventors: Hervé THELLIER, PIMPREZ (FR); Thierry OLIVIER, THOUROTTE (FR)

(21) Appl. No.: 16/488,793

(22) PCT Filed: Feb. 22, 2018
(86) PCT No.: PCT/FR2018/050430

§ 371 Date: Aug. 26, 2019

(30) Foreign Application Priority Data
Feb. 27, 2017 (FR) 1751568

(51) Int. Cl. C03B 23/025; C03B 23/03; C03B 23/035; C03B 35/14; C03B 35/20

(52) U.S. Cl. CPC C03B 23/0252; C03B 23/0302; C03B 35/202; C03B 35/145; C03B 23/0357

(57) ABSTRACT

A device and a method for bending and cooling sheets of glass including bending the glass by gravity on a gravity support during which the glass rests on the gravity support in the peripheral zone constituted of the 50 mm from the edge of its first principal face, then separating the glass from the gravity support when the glass is at more than 560° C., then cooling the glass during which its first principal face is free of any contact in its peripheral zone, between a temperature termed the upper homogeneous temperature, of at least 560° C., and a temperature termed the lower homogeneous temperature, of at most 500° C., termed the critical temperature range, the zone of the first principal face at a distance greater than 200 mm from the edge being at a temperature at least equal to that of the peripheral zone at the moment when the peripheral zone reaches the upper homogeneous temperature.

The invention concerns a method of manufacturing bent, in particular laminated glazing, and proposes an improvement to the step of cooling the glass after bending it with a view to obtaining reduced tension stresses. The invention concerns bending methods involving a step of bending on a gravity bending support termed a gravity support.

The invention concerns in particular the production of laminated glazing of the windshield or roof type for road vehicles (automobiles, trucks, buses), but also any glazing for aeronautics or construction.

In gravity bending processes, the tooling supporting the glass termed a “gravity support”, with a shape adapted to the final geometry of the glass, is in contact with the periphery of the lower face of the glass during all the shaping phases, that is to say rough bending, bending and cooling. Accordingly, for each glazing design it is necessary to have a particular series of gravity supports the number of which is at least equal to the number of different process steps. A gravity support generally has the shape of a frame. It is preferably covered with a refractory fibrous material well known to the person skilled in the art that comes into contact with the glass. The width of its contact track with the glass is generally in the range from 3 to 20 mm, refractory fibrous material included.

When the glass exits the bending step to begin the cooling phase, in the prior art it is usually in contact at its periphery with the last gravity support, in particular between 5 and 10 mm from the edge of the glass. When the glass sets and cools, a physical phenomenon is created generating permanent stresses that correspond to the conversion of the distribution of temperature in the glass into a stress field. This phenomenon is initiated during the setting of the glass and terminates at the end of cooling when a homogeneous temperature distribution is reached. In qualitative terms, the parts where the glass sets first correspond to the parts where the compression stresses are concentrated whereas the parts where the glass sets after a delay concentrate the tension stress zones. The edge stresses described in the context of the present invention are membrane stresses that may be defined at any point in the material and for a given direction as the mean of the stress field at that point and in that direction, the mean being calculated throughout the thickness of the sample. At the sample edge, only the membrane stress component parallel to the edge is pertinent; the perpendicular component has a zero value. Also any method of measurement enabling measurement of the mean stresses along an edge and throughout the thickness of the sample is pertinent. The methods of measuring edge stresses utilize photoelastic techniques. The two methods described in the ASTM standards cited below enable measurement of the edge stress values:
the method utilizing the Babinet compensator is described in the standard ASTM C1279-2009-01, procedure B;
the measurement effected with commercial apparatus such as the Sharples S-67 marketed by the company Sharples Stress Engineers, Preston, UK and utilizing a so-called Sénarmont or Jessop-Friedel compensator; the measurement principle is described in the standard ASTM F218-2005-01.

In the context of the present application, the compression stress values are determined by the method described in the standard ASTM F218-2005-01. The tension measurements are effected using the same method in a zone parallel to the edge of the glazing but situated slightly farther toward the interior of its area.

The compression stress values are generally determined between 0.1 and 2 mm from an edge and preferably between 0.1 and 1 mm from an edge. When the measurement is effected in the vicinity of the edge and within the glazing, an edge tension stress zone is generally identified within a peripheral zone situated between 3 and 100 mm from the edge of the glass.

Finally, it must be stated that the tension stresses relate to the membrane stresses of the exterior sheet of glass in the glazing (when mounted on the vehicle), which may be measured either on the exterior sheet of glass alone before lamination or on the exterior sheet of glass after lamination using the commercial apparatus Sharples model S-69 marketed by the company Sharples Stress Engineers, Preston, UK. For the measurement effected after assembly to be pertinent, it is necessary to colorize the interior surface of the exterior sheet of glass of the glazing using black or metallic paint. This sheet in the external position on the vehicle corresponds to the sheet in the lower position during bending by the method according to the invention and in the case of a stack of sheets of glass.

The current specifications on glazing properties require pertinent edge compression values greater than 8 MPa and the lowest possible edge tensions to preserve the mechanical robustness of glazing during mounting and use.

The invention enables prevention of the disturbance to the temperature distribution induced by contact of the periphery of the glass with a gravity support during cooling. Also, the edge compression levels cited above are more easily attained with greater safety margins and the tension stress levels are reduced.

EP2532625 teaches a device for supporting the glass after cooling its surface below its strain point. The central zone of the glass is cooled below the strain point before the edge. This technique is applied to annealing the glass. It is necessary to cool the interior of the glass to be able to lift the glass off its support. This causes compression of this central zone, which must necessarily be counterbalanced by a tension zone at its periphery. The cooling of the central zone therefore risks the creation of higher peripheral tension stresses that can weaken the glass. Moreover, if the annealing step is insufficiently well controlled and the glass remains for too long at too high a temperature during this phase, the surface compression level could be insufficient.

A prior art gravity bending method using a series of gravity supports gives rise to the following problems:

1. the rate of cooling depends on numerous parameters linked to the furnace; there may be cited the cycle time, the mass of the glazing and the onboard cooling, the pressure in the furnace; the latter is difficult to control and necessitates numerous attempts at setting parameters and onboard temperature measurements;

2. even if the rate of cooling is well controlled, it is very difficult to apply fine control of the temperature profile at the edge of the glass when the latter sets over the entire periphery of the glazing; also, stresses departing from the specifications may occur locally; artifice is then required, directly on the tooling, for local correction of these discrepancies, which is costly in testing and maintenance time if the stress level is to be maintained over time;

3. to guard against problems of weakness in use (sensitivity to impact of gravel in the case of automobile glazing for example), automobile manufacturers require that the residual tension stresses be significantly lower than 8 MPa; the cooling of glazing on its gravity support in a simple cooling chamber does not make it possible to achieve values of less than 5 MPa over all the perimeter;

4. a large number of specific tools for each design produced is necessary, because they transport the glass in all steps of the process including the cooling phases, which is reflected in high investment, maintenance and energy costs; each gravity support goes through all the temperature cycle of the process and therefore through very different temperatures, which is costly in terms of energy.

The inventors of the present invention have carried out the following analysis. Problems 2 and 3 above stem from the fact that the glazing is supported by a gravity support at its edge at the time of cooling, and that this support prevents homogeneous cooling of the glass, in particular at the edge. In fact, the contact of the edge of the glass with the support is damaging because the latter cools more slowly than the glass and its contact with the periphery of the glass interferes with its cooling. This phenomenon occurs as a consequence of heat transfer by conduction between the glass and the support and by radiation following the masking of the bed plate of the furnace by the support. This results in high tension stresses.

In the present application, the glass is in the form of a single sheet or more generally in the form of a stack of several sheets, or even more generally a stack of two sheets. In order to simplify the description of the invention, the term “glass” is used to designate a sheet or a stack of sheets. Whether a single sheet or a plurality of stacked sheets is concerned, the glass comprises two external principal faces, here termed the first principal face and the second principal face, gravity bending being effected on a gravity support by supporting the glass on its first principal face, which faces downward. In the case of a stack, the sheets remain stacked throughout the bending and cooling process, in order to guarantee identical shaping of all the sheets intended to be assembled. The association of these sheets of glass in the final laminated glazing is therefore arrived at under better conditions, leading to laminated glazing of better quality.

The invention concerns the method of the independent method claim. The invention also concerns the device of the independent device claim. The method according to the invention may be carried out using the device according to the invention.

The invention more particularly concerns a method of manufacturing bent glass comprising bending and cooling a sheet of glass or of a stack of sheets of glass, termed the glass, comprising a first principal face and a second principal face, said method comprising gravity bending of the glass on a gravity support during which the glass rests on the gravity support through contact with the peripheral zone of its first principal face, said peripheral zone being constituted of the 50 mm from the edge of the first principal face, then separation of the glass from the gravity support while the glass is at a temperature of more than 560° C., then cooling the glass with its first principal face free of any contact in its peripheral zone between a temperature termed the upper homogeneous temperature, of at least 560° C., and a temperature termed the lower homogeneous temperature, of at most 500° C., this range being termed the critical temperature range.

In the context of the present application, the peripheral zone of the first principal face of the glass is without contact in the critical temperature range, which means that this peripheral zone is free of any contact with a solid, that is to say is exclusively in contact with the gaseous atmosphere. During bending on the gravity support, the contact with the gravity support is entirely in the peripheral zone, without contact with the glass beyond the peripheral zone. The separation of the glass from the gravity support then takes place when the latter is at a temperature of more than 560° C., it being understood that the entirety of the glass (peripheral zone and central zone) is at a temperature above that temperature at this time. At the moment of separation, the zone of the first principal face farther than 50 mm from the edge of the glass, termed central zone, is at a temperature higher than that of the peripheral zone. The central region of the first principal face of the glass, in particular the zone of the first principal face of the glass more than 200 mm from the edge and even generally more than 170 mm from the edge and even generally more than 50 mm from the edge is at a temperature at least equal to, and generally greater than, that of the peripheral zone at the moment when the peripheral zone reaches the upper homogeneous temperature and preferably also at the moment when the peripheral zone reaches the lower homogeneous temperature, and more generally between the moment of the separation from the gravity support until at least the moment when the peripheral zone reaches the upper homogeneous temperature and even the lower homogeneous temperature.

The temperature range between the upper homogeneous temperature and the lower homogeneous temperature is termed the critical temperature range and the time to go from the upper homogeneous temperature to the lower homogeneous temperature is termed the critical cooling time. The upper homogeneous temperature is preferably at least 575° C. The lower homogeneous temperature is preferably at most 490° C.

During cooling of the glass in the critical temperature range, the first principal face of the glass is preferably without contact in the 60 mm from the edge and preferably without contact in the 70 mm from the edge. During cooling of the glass in the critical temperature range, the first principal face of the glass is preferably without contact beyond 200 mm from the edge and preferably without contact beyond 170 mm from the edge and preferably without contact beyond 150 mm from the edge. It is therefore possible to define a “contact band” of the first principal face of the glass in which the glass is preferably supported when it is in the critical temperature range:
outer limit of the band: at least 50 mm and preferably at least 60 mm and preferably at least 70 mm from the edge of the glass,
inner limit of the band: at most 200 mm and preferably at most 170 mm from the edge of the glass and preferably at most 150 mm from the edge of the glass,
   without any contact of a solid with the glass outside those limits. The outer and interior limits of this band are parallel to the edge of the glass.

The absence of contact of any solid with the peripheral zone, even in the 60 mm or even in the 70 mm from the edge, of the first principal face of the glass results in homogenization in temperature of this zone. By homogeneous temperature is meant that the temperature of the glass does not vary by more than 5° C. and preferably by not more than 1° C. and preferably by not more than 0.6° C. over this 50 mm peripheral zone. In practice, the homogeneous temperature of the glass is verified by measurements using a thermal video camera on the first principal face of the glass. This homogeneity is achieved for each of the sections perpendicular to the edge of the glass but one section may have a different temperature to another section. The peripheral zone of the first principal face is homogeneous in temperature on any line at the intersection of a section perpendicular to the edge of the glass in the critical temperature range (between the upper homogeneous temperature and the lower homogeneous temperature).

The glass used in the context of the present invention is a sodacalcic glass. It is conventionally formed by the float process and routinely used for automotive applications. According to the invention, the control of the stresses generated in the glass is improved by separating the latter from its last gravity support and then homogenizing the temperature of its peripheral zone and cooling the glass as far as the end of the critical temperature range whilst preserving temperature homogeneity. It is the first principal face of the glass that must have a particular resistance, in particular impact resistance, because it is usually positioned externally on a vehicle. This first principal face, also termed “face 1” by the person skilled in the art, is usually convex (the face 4 is the face inside the vehicle if the laminated glazing comprises two sheets of glass). It is therefore this face that is in the lower position (and the exterior position in a stack) during bending and in contact with the last gravity support, as well as during the critical cooling time that follows bending.

In the context of the present application, the expression “specific support” designates a support for supporting the glass from below but without contact with the glass in the peripheral zone of its downward-facing first principal face (the 50 mm edge portion of that first principal face). Various types of specific support are described hereinafter. The present application refers to a specific cooling support, a specific preliminary support, a specific offloading support.

According to the invention, the first principal face of the glass is separated from the last gravity support at a temperature greater than the upper homogeneous temperature so as to be able to homogenize the temperature of the peripheral zone of that face. This same face of the glass may be placed on the specific support in at least a part of the critical temperature range to continue the cooling of the glass whilst preserving the temperature homogeneity of the peripheral zone. Once the temperature of this first principal face is homogeneous in its peripheral zone the glass may be cooled more rapidly, even in the critical temperature range.

Thanks to the invention, the edge compression stresses of the finished glass in the sheet comprising the first principal face are greater than 8 MPa, or even greater than 10 MPa and can even range up to 20 MPa, and are more homogeneous along the periphery of the glass. Moreover, the tension levels are significantly reduced, to less than 5 MPa and even to less than 4 MPa, or even to less than 3 MPa. The passage from the compression zone to the tension zone is generally located at a distance from the edge between 1 and 5 mm. The maximum tension stress is generally situated at a distance from the edge between 5 and 40 mm and more generally between 15 and 40 mm.

The mechanical robustness of the glazing obtained may be evaluated by impacting the face 1 of the glazing using Vickers points. A test of this kind enables evaluation of the resistance of windows to impact from gravel when they are installed on a vehicle. The higher the impact energy of the indenter without the glass cracking, the greater is its robustness. The glazing obtained by the method according to the invention is more robust than if their manufacture includes cooling it on its gravity support. This improved robustness is imputed to a reduced edge tension level.

Moreover, as stated above the edge tension stress that, to a first order, determines the fragility of the glazing is a membrane stress, equivalent at every point M of the surface of a sheet of glass to the mean of the stresses within the thickness thereof at that point. This mean is therefore calculated along the segment “S” that is perpendicular to the sheet of glass at the point M and that passes completely through it. Also, different stress profiles may exist along the segment S that correspond to the same tension stress value. Of the various possible stress profiles, profiles in which the first principal face of the glass is in compression are of the greatest benefit for mechanical strength. In fact, the skin of the first principal face in compression then acts like a protection layer that blocks the propagation of surface defects and prevents them from being transformed into cracks both in the thickness of and in directions parallel to the surface of the sheet of glass. In contrast, the stress profiles that it is necessary to attempt to proscribe are those in which the first principal face of the glass is in tension.

During the discussion of the stress generation mechanisms, it was stated that the zones in tension correspond to the locations where the glass has set with a delay. It was also stated that in the prior art the cooling of the glass in contact with its gravity support indeed encourages a delay in cooling in regions situated in the vicinity of the contact zone between the glass and the gravity support.

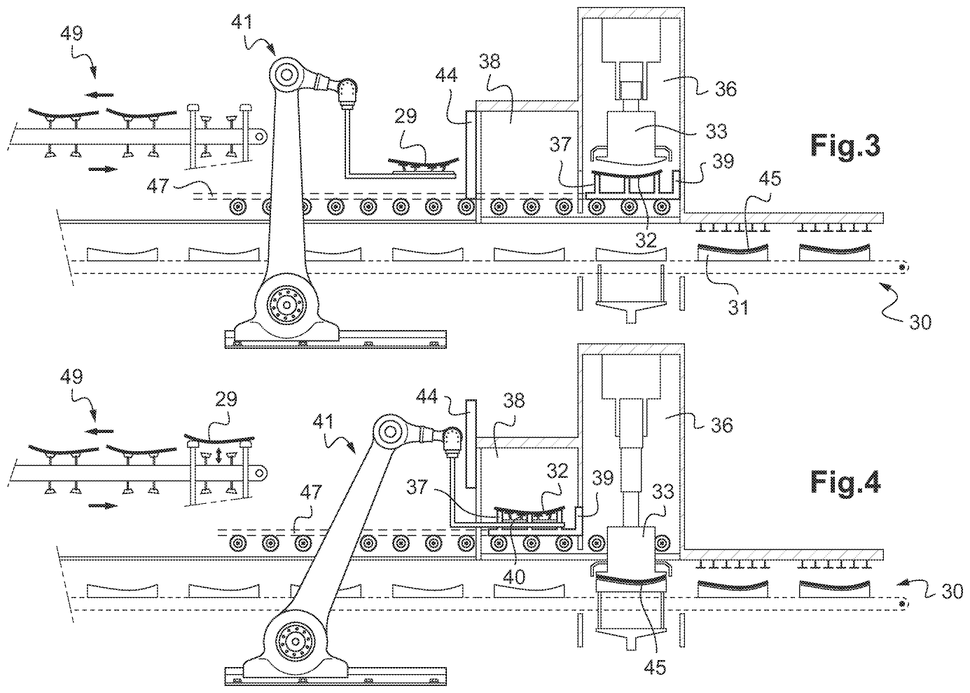

The cooling of the glass on its gravity support therefore encourages both a mean cooling time (in the thickness of the exterior sheet of the glass) along a zone inside the glass and situated in the vicinity of the edge but also, in that same peripheral zone, a delay in cooling the first principal face of the glass which consequently itself tends to be in tension. The improved robustness of the glass obtained in accordance with the invention is therefore also attributed to a globally higher surface compression level. To achieve temperature homogeneity in the peripheral zone of the first principal face of the glass, that peripheral zone is preferably free of contact with any tool (that is to say in contact exclusively with the gaseous atmosphere) for a sufficient time before reaching the upper homogeneous temperature for homogenization to be obtained. This temperature homogenization time is generally at least 5 seconds and preferably at least 6 seconds and even at least 7 seconds. It is preferably the whole of the first principal face that is totally without contact during this temperature homogenization time. This homogenization is indeed obtained with the glass held by suction on its principal second face and with no contact with its first principal face, thanks to an upper forming mold having a skirt and suction means aspirating air between it and the skirt, termed hereinafter simply the upper forming mold, the suction by the skirt providing the force holding the glass against the forming mold. An upper forming mold of this kind is shown for example in FIG. 3 of WO2011/144865, the skirt being the element 39 thereof. The air aspirated by the skirt and circulating in the vicinity of the edge portion of the glass encourages the homogenization of the temperature of the peripheral zone of the first principal face of the glass. The upper forming mold preferably takes the form of a frame, that frame preferably being covered with a refractory fibrous material in order to reduce the risk of marking the surface of the second principal face of the glass. This frame may have a width in the range from 3 to 20 mm, including the fibrous material. This upper forming mold comes into contact with the glass without extending beyond its edge so as not to disturb the exasperation air flow. This upper forming mold may come into contact with the glass so that it exterior edge arrives at a distance from the edge of the glass in the range from 3 to 20 mm.

Although this is not recommended, there is nothing to rule out placing the glass at a temperature above the upper homogeneous temperature on a specific support preserving the temperature homogeneity of the peripheral zone of the first principal face of the glass. If a specific support is used, it is preferable to place the glass on it at a temperature below the upper homogeneous temperature. The glass may be carried by a specific support (or a plurality thereof in succession) at least until the lower homogeneous temperature is reached (end of critical cooling time) and generally also at a lower temperature than the lower homogeneous temperature. If necessary, the glass may be supported by a succession of specific supports between a temperature included in the critical temperature range and a temperature below the critical temperature range.

According to the invention, the bending of the glass may comprise complementary bending against a solid bending forming mold. This complementary bending follows the bending on the gravity support. This complementary bending may notably be carried out on a lower bending mold, notably by suction, termed a suction lower mold. This suction lower mold is a solid forming mold with orifices through which suction is applied to the first principal face of the glass. This solid forming mold is at least as large as the sheet and therefore extends as far as its edge. It does not significantly modify the homogenous or non-homogenous character of the temperature of the peripheral zone of the first principal face of the glass. A suction lower mold of this kind is for example of the type shown in FIG. 2 of WO2006072721.

In the situation where complementary bending is carried out, the latter takes place at a temperature greater than 570° C. and even greater than 580° C. The complementary bending temperature is generally lower than that of gravity bending. After this complementary bending, it is necessary to separate the glass from the suction lower mold and to leave the peripheral zone of the first principal face of the glass free of contact for the time necessary for homogenization of the periphery of the lower face of the glass before it reaches the upper homogeneous temperature.

During the method according to the invention, the first principal face of the glass, generally in the lower position, is in contact with the gravity support, and possibly thereafter with a suction lower mold, and thereafter with at least one specific support.

The passage from the gravity support to the lower suction mold or directly to the specific support can advantageously be achieved by the use of a suction upper forming mold. The passage from the suction lower mold to the specific support may also advantageously be carried out using a suction upper forming mold.

An upper forming mold generally takes charge of the glass by its upper second face and releases it onto a support placed under it and able to support the glass from below, whether this be a suction lower mold or a specific support. The suction means of an upper forming mold are triggered at the moment it has to take charge of the glass and is stopped so that it is able to release it. The supports (gravity support, suction lower mold, specific support) that have to be offloaded or loaded with the glass by an upper forming mold are generally mobile laterally and can pass under the upper forming mold to make it possible to transfer the glass with the upper forming mold. To make this transfer possible, these supports and/or the upper forming mold are driven with a vertical relative movement enabling them to move toward one another or away from one another. After movement toward one another, the upper forming mold can take hold of or release the glass onto one of these supports. This transfer being done, the upper forming mold and the support move apart vertically and the support (whether loaded with glass or not, depending on the type of transfer) is moved laterally. Another support loaded or not with glass depending on the transfer to be carried out can then be placed under the upper forming mold.

If an upper forming mold releases the glass onto a suction lower mold type support, the glass is lightly pressed at its periphery between the upper forming mold and the suction lower mold for the time for which the suction of the suction lower mold is triggered in order to seal the periphery of the first principle face of the glass with the suction lower mold, together with the periphery of any other sheets of glass between them in a stack. The suction by the suction lower mold then acts immediately on the lower face of the glass (with no leaks at the edges), and in the case of a stack the vacuum is communicated to all its sheets. For this pressing to be effective, the suction lower mold and the upper forming mold releasing the glass onto it must have complementary shapes.

An upper forming mold is advantageously placed in a chamber maintained at a substantially constant temperature. The device according to the invention may comprise a plurality of juxtaposed chambers maintained at different and decreasing temperatures on the path of the glass. The first chamber on the path of the glass is termed the separation chamber and comprises a separation upper forming mold responsible for separating the glass from its last gravity support and releasing it onto a specific support or a suction lower mold. The last chamber on the path of the glass is termed the cooling chamber and generally does not comprise any upper forming mold. A specific support carrying the glass termed the cooling specific support may enter therein and the glass may be offloaded from it thanks to a support termed an offloading support, the latter passing under the glass and rising to take charge of it and to exit from the cooling chamber. The device may further comprise a transfer chamber situated between the separation chamber and the cooling chamber, in particular for the situation in which the separation upper forming mold releases the glass onto a preliminary support preceding the cooling specific support. That preliminary support may be a suction lower mold or a specific support different from the cooling specific support and termed a preliminary specific support. The transfer chamber is equipped with an upper forming mold the role of which is to offload the glass from the preliminary support coming from the separation chamber and release it onto the cooling specific support.

The device according to the invention therefore generally comprises two or three chambers each maintained at a substantially constant temperature but the temperatures of which chambers decrease along the path of the glass. In the case of two chambers, the laterally mobile cooling specific support shuttles between the two chambers. It receives the glass in the separation chamber, then enters the cooling chamber in which it is offloaded of the glass, then returns empty into the separation chamber to receive the next glass, and so on. In the case of three chambers, the laterally mobile preliminary support shuttles between the separation chamber in which it receives the glass and the transfer chamber in which it is offloaded of the glass and then returns empty to the separation chamber to receive the next glass, and so on. During this time, the cooling specific support, mobile laterally, shuttles between the transfer chamber in which it receives the glass and the cooling chamber in which it is offloaded of the glass and then returns empty to the transfer chamber to receive the next glass, and so on. In the system with three chambers, the presence of a supplementary chamber enables the reduction of temperature to be staggered more progressively.

Shuttling between two juxtaposed chambers, these supports participate in cooling the glass progressively, without themselves undergoing the whole thermal cycle to which the glass is subjected. These supports therefore always remain hot, which contributes to saving energy, and they are able to pass very rapidly from one chamber to the other. The manufacturing cycle can therefore be very fast. These supports shuttling between two chambers carry turn and turn about all the glass of a production run. They are therefore manufactured only once, which also works toward cost reduction.

Moreover, the temperature of the gravity supports may be higher on entering the bending furnace. In fact, the supports being offloaded at a temperature of more than 560° C., they are able to return relatively hot, in particular at temperatures between 200 and 500° C. at the entry of the furnace, without undergoing strong cooling. Maintaining the gravity supports at high temperatures significantly reduces the quantity of energy necessary to heat them and, moreover, they also serve to heat the glass as soon as it is loaded. The path to be taken by the gravity supports is also shortened. All these elements work toward cost reduction.

The gravity supports each loaded with glass are able to circulate like a train in a tunnel furnace for bending of the glass by gravity generally at a temperature between 590 and 750° C. depending on the composition of the glass. The temperature of the furnace decreases toward the end, producing slow cooling, at between 0.4 and 0.8° C./second, until the glass is at a temperature generally around 585° C. The train passes under the separation upper forming mold, the latter taking charge of the glass from each of the gravity supports one after the other. The separation of the glass from its gravity support occurs at a temperature greater than 560° C. and preferably at a temperature greater than 575° C., or even greater than 590° C. The glass sags under its own weight by virtue of its passage in the tunnel furnace at its plastic deformation temperature before arriving in position under the separation upper forming mold. Each support carrying a bent glass stops under the separation upper forming mold. By vertical relative movement of the separation upper forming mold and the gravity support in position below it, the forming mold is moved sufficiently toward the glass to be able to take charge of it after its suction is triggered. The first upper forming mold then rises so that a support (of the specific support or suction lower mold type) that is laterally mobile can be positioned under it. It then moves toward that support and releases the glass onto it by stopping the suction.

The glass generally passes through the whole of the critical temperature range either supported by at least one specific support or being held by its second principal face by at least one upper forming mold provided with suction means, with the result that the peripheral zone of the first principal face of the glass is never in contact with a solid.

The devices used comprise separation and transfer means able to separate the glass from the gravity support and to deposit it on a so-called cooling specific support. The separation and transfer means comprise a separation upper forming mold provided with suction means, in particular of the skirt type, enabling the glass to be held against it by its second principal face, said separation upper forming mold being able to take charge of the glass and offload it from the gravity support. The suction functions in order for the separation upper forming mold to be able to take charge of the glass and to offload it from the gravity support, and then to move away from the gravity support carrying the glass. The upper forming mold holding the glass against it is then positioned over another support, after which the suction is stopped so that the upper forming mold can release the glass onto that other support. As already explained, this other support may be the cooling specific support itself or a preliminary support preceding the cooling specific support. This preliminary support may be a suction lower mold or a specific support different from the cooling specific support and termed a preliminary specific support. The separation upper forming mold holds the glass by its second principal face which in particular enables the first principal face of the glass to be free of any contact with any solid, which is favorable to the temperature homogenization of this first principal face of the glass in its peripheral zone.

An embodiment is described hereinafter employing two chambers and a cooling specific support shuttling between the two chambers. In this embodiment, the separation and transfer means comprise a separation chamber comprising a separation upper forming mold provided with skirt type suction means enabling the glass to be held against it by its second principal face. The gravity support is mobile laterally and able to be positioned under the separation upper forming mold, the gravity support and the separation upper forming mold are adapted to be moved toward one another or away from one another (by movement of either one or both of them) so that the separation upper forming mold can take charge of the glass and offload it from the gravity support and can then be moved away from the latter on rising into the separation chamber with the glass, the cooling specific support is mobile laterally and able to be positioned under the separation upper forming mold or to be moved away from the latter, and the cooling specific support and the separation upper forming mold are able to be moved toward one another or away from one another (by movement of either one or both of them) so that the separation upper forming mold can release the glass onto the cooling specific support. The gravity support carrying the glass is positioned under the separation upper forming mold, after which the glass separated from the gravity support by the separation upper forming mold and held by the separation upper forming mold in the separation chamber at a temperature lower than the temperature of the glass on the gravity support at the moment of separation, after which the cooling specific support, being mobile laterally and able to enter or exit the separation chamber, is positioned under the glass and the separation upper forming mold releases the glass onto it, after which the cooling specific support carrying the glass exits the separation chamber for continued cooling of the glass.

The glass on its gravity support passes under the separation chamber. The separation upper forming mold and the gravity support are then moved toward one another by vertical relative movement and the separation upper forming mold takes charge of the glass, separates it from the gravity support and raises it substantially high in the separation chamber for the cooling specific support, then empty, to be able to pass under the glass. The temperature of the separation chamber is lower than that of the glass at the moment the separation upper forming mold takes charge of it. In particular, the temperature of the separation chamber may be between 540 and 585° C. The suction serving to hold the glass against the separation upper forming mold by the second principal face of the glass contributes to the homogenization of the temperature of the peripheral zone of the first principal face of the glass. The glass is therefore held for at least 5, and even at least 6 or even at least 7 seconds. The separation upper forming mold and the cooling specific support are then moved toward one another by vertical relative movement and the separation upper forming mold releases the glass onto the cooling specific support, after which the separation upper forming mold and the cooling specific support are separated again. The cooling specific support then carries the glass by lateral movement into a cooling chamber the temperature of which is set to a temperature lower than the temperature of the separation chamber, and in particular may be between 400 and 565° C. The separation upper forming mold can then take charge of the next glass. An offloading support then enters the cooling chamber, passes under the glass and then rises on taking charge of it and exits it from this chamber for its continued cooling. In this variant, the passage of the first principal face of the glass (in the lower face position) below the upper homogeneous temperature may be effected on the cooling specific support but is preferably effected while the glass is held against the separation upper forming mold, the glass thereafter being placed on the cooling specific support in the critical temperature range. On that support, the glass can be cooled relatively rapidly, at a mean rate between 0.8 and 2.5° C./second. The glass may exit the cooling chamber carried by the offloading support while its first principal face is still in the critical temperature range if the offloading support is a support of the specific support type. The offloading support advantageously takes charge of the glass when the latter is at a temperature between 520 and 540° C.

An embodiment is described hereinafter employing three chambers with two specific supports each shuttling between two chambers. According to this variant, the separation and transfer means comprise
a separation chamber comprising a separation upper forming mold provided with suction means in particular of the skirt type enabling the glass to be held against it by its second principal face,
a transfer chamber comprising a transfer upper forming mold provided with suction means in particular of the skirt type enabling the glass to be held against it by its second principal face,
a preliminary specific support able to support the glass without contact with the peripheral zone of its first principal face.

The gravity support is mobile laterally and able to be positioned under the separation upper forming mold, the gravity support and the separation upper forming mold are able to move toward one another or away from one another (by movement of either one or both of them) so that the separation upper forming mold can take charge of the glass, offload it from the gravity support and then move it away therefrom, the preliminary specific support is mobile laterally and able to enter the separation chamber, to be positioned under the separation upper forming mold, the preliminary specific support and the separation upper forming mold are able to be moved toward one another or away from one another so that the separation upper forming mold can release the glass onto the preliminary specific support and then move away therefrom, the preliminary specific support is able to exit the separation chamber loaded with glass and then able to enter the transfer chamber (the exit from the separation chamber and the entry of the transfer chamber generally being concomitant during the same lateral movement) and to be positioned under the transfer upper forming mold, the preliminary specific support and the transfer upper forming mold are able to be moved toward one another or away from one another (by movement of either one or both of them) so that the transfer upper forming mold can take charge of the glass, offload it from the preliminary specific support, and the be moved away from the latter, the cooling specific support is mobile laterally and able to enter or to exit the transferred chamber and to be positioned under the transfer upper forming mold or to be moved away from that position, and the cooling specific support and the transfer upper forming mold are able to be moved toward one another or away from one another so that the transfer upper forming mold can release the glass onto the cooling specific support. Compared to the preceding situation, a supplementary chamber, termed the transfer chamber, is located between the separation chamber and the cooling chamber and a preliminary specific support precedes the cooling specific support and shuttles between the separation chamber and the transfer chamber.

The gravity support carrying the glass is positioned under the separation upper forming mold, after which the glass is separated from the gravity support by the separation upper forming mold and held against the separation upper forming mold in a separation chamber at a temperature lower than the temperature of the glass on the gravity support at the moment of separation, after which the preliminary specific support, mobile laterally and able to enter or exit the separation chamber, is positioned under the glass, after which the separation upper forming mold releases the glass onto it, after which the preliminary specific support carrying the glass exits the separation chamber and enters the transfer chamber equipped with the transfer upper forming mold, the temperature of the transfer chamber being lower than the temperature of the separation chamber, after which the glass is separated from the preliminary specific support by the transfer upper forming mold, after which a specific support able to support the glass without contact with the peripheral zone of its first principal face, termed a cooling specific support, is positioned under the glass and the transfer upper forming mold releases the glass onto it, after which the cooling specific support carrying the glass exits the transfer chamber for continued cooling of the glass. For continued cooling of the glass, the cooling specific support carrying the glass can enter a cooling chamber set to a temperature lower than the temperature of the transfer chamber, the cooling chamber being able to be at a temperature between 350 and 520° C.

The beginning of the process starts as in the preceding situation (preceding situation: two chambers and a cooling specific support) up to the point of release of the glass by the separation upper forming mold since for this the separation upper forming mold and the preliminary specific support are moved toward one another by vertical relative movement and the separation upper forming mold releases the glass onto the preliminary specific support, after which the separation upper forming mold and the preliminary specific support are separated again. The preliminary specific support then moves the glass laterally into the transfer chamber. The separation upper forming mold can then take charge of the next glass. In the transfer chamber, the transfer upper forming mold and the preliminary specific support are moved toward one another by vertical relative movement and the transfer upper forming mold takes charge of the glass and rises to allow the empty preliminary specific support to go back into the separation chamber in order to receive the next glass. The cooling specific support (empty at this stage) is positioned under the transfer upper forming mold, after which the cooling specific support and the transfer upper forming mold are moved toward one another and the transfer upper forming mold releases the glass onto the cooling specific support and then rises to allow the cooling specific support carrying the glass to enter the cooling chamber. An offloading support then enters the cooling chamber, passes under the glass and then rises, takes charge of it and exits it from this chamber for continued cooling. In this variant, the passage of the first principal face of the glass (in the lower face position) below the upper homogeneous temperature may occur when the glass is on the preliminary specific support, in the separation chamber or in the transfer chamber, or when the glass is held against the separation upper forming mold, the glass then being placed on the preliminary specific support in the critical temperature range. On that support as well as on the cooling specific support the glass may be cooled relatively rapidly, at a mean rate between 0.8 and 2.5° C./second. The passage of the peripheral zone below the lower homogeneous temperature may occur in the cooling chamber. The glass may also leave the cooling chamber carried by the offloading support while its first principal face is still in the critical temperature range if the offloading support is a support of the specific support type. The presence of three chambers makes it possible to stagger the temperature slightly more progressively. The separation chamber may therefore be in the temperature range 550-590° C., the transfer chamber may be in the temperature range 500-560° C. and the cooling chamber may be in the temperature range 350-520° C., it being understood that the temperature of the cooling chamber is lower than that of the transfer chamber and that the temperature of the transfer chamber is lower than that of the separation chamber. The temperature of the separation chamber is lower than that of the glass at the moment it is taken charge of by the separation upper forming mold. From the separation of the glass from the gravity support and at least until the glass exits the cooling chamber the peripheral zone of the first principal face of the glass is not in contact with any solid.

An embodiment is described hereinafter using three chambers with a shuttle suction lower mold and a shuttle specific support.

This system is substantially identical to the preceding one except that the preliminary specific support is replaced by a suction lower mold serving as a preliminary support. This mold terminates the bending of the glass in the case of relatively complex shapes. The temperature range of the chambers is substantially identical to the preceding situation. However, in this variant, the passage of the first principal face of the glass (in the lower face position) below the upper homogeneous temperature occurs after bending on the suction lower mold, in particular when the glass is held against the transfer upper forming mold. The glass is then placed on the cooling specific support in the critical temperature range.

According to this variant, the separation and transfer means comprise
the separation chamber comprising a separation upper forming mold provided with suction means in particular of the skirt type enabling the glass to be held against by its second principal face,
a transfer chamber comprising a transfer upper forming mold provided with suction means in particular of the skirt type enabling the glass to be held against it by its second principal face,
a suction bending lower mold able to bend the glass by suction on its first principal face, termed the suction lower mold.

The gravity support is mobile laterally and able to be positioned under the separation upper forming mold, the gravity support and the separation upper forming mold are able to be moved toward one another or away from one another so that the separation upper forming mold can take charge of the glass, offload it from the gravity support and then be moved away from the latter, the suction lower mold is mobile laterally and able to enter the separation chamber, to be positioned under the separation upper forming mold, the suction lower mold and the separation upper forming mold are able to be moved toward one another or away from one another so that the separation upper forming mold can release and press the glass onto the suction lower mold and then be moved away from the latter, the suction lower mold is able to exit the separation chamber loaded with glass and then able to enter the transfer chamber (the exit of the separation chamber and the entry of the transfer chamber generally being concomitant during the same lateral movement) and to be positioned under the transfer upper forming mold, the suction lower mold and the transfer upper forming mold are able to be moved toward one another or away from one another (by movement of either one or both of them) so that the transfer upper forming mold can take charge of the glass, offload it from the suction lower mold and then be moved away from the latter, the cooling specific support is mobile laterally and able to enter or to exit the transfer chamber and to be positioned under the transfer upper forming mold or to be moved away from that position, and the cooling specific support and the transfer upper forming mold are able to be moved toward one another or away from one another (by movement of either one or both of them) so that the transfer upper forming mold can release the glass onto the cooling specific support.

The gravity support carrying the glass is positioned under the separation upper forming mold, after which the glass is separated from the gravity support by the separation upper forming mold and held against it in the separation chamber at a temperature lower than the temperature of the glass on the gravity support at the moment of separation, after which a bending suction lower mold able to bend the glass by suction on its first principal face, termed a suction lower mold, mobile laterally and able to enter or to exit the separation chamber is positioned under the glass, after which the separation upper forming mold releases the glass onto it, after which the suction lower mold carrying the glass exits the separation chamber and enters the transfer chamber, the temperature of the transfer chamber being lower than the temperature of the separation chamber, the glass being bent on the suction lower mold in the separation chamber and/or the transfer chamber, after which the glass is separated from the suction lower mold by the transfer upper forming mold, after which the cooling specific support is positioned under the glass and the transfer upper forming mold releases the glass onto it, after which the cooling specific support carrying the glass exits the transfer chamber for continued cooling of the glass. For continued cooling of the glass, the cooling specific support carrying the glass can enter a cooling chamber set to a temperature lower than the temperature of the transfer chamber, the cooling chamber being able to be at a temperature between 350 and 520° C.

In the context of the present invention, a so-called specific support is used, with no contact with the peripheral zone of the first principal face of the glass, in at least a part of the critical temperature range. Different types of specific support may be envisaged.

According to one embodiment a specific support comes into contact with the first principal face of the glass through a plurality of contact zones touching the glass only in the “contact band” defined above. The supporting surface of the specific support coming into contact with the glass is therefore discontinuous.

Each contact zone preferably has on its surface a refractory fibrous material well known to the person skilled in the art to reduce the risk of marking of the hot glass by a tool. This fibrous material can be a woven or felt or knitted material and in particular a “tempering knitted material” usually serving to cover the peripheral rings supporting the glazing during annealing and having the advantage of having an open texture. It contains refractory fibers and has a high open porosity that confers on it a property of thermal insulation. A specific support of this kind may comprise 4 to 300 contact zones. The greater the number of contact zones, the smaller the contact area of each zone. The sum of the areas of all the contact zones may represent 0.2 to 5% of the area of the first principal face of the sheet of glass in the lower position. The contact area of each contact zone may be in the range from 50 mm² to 5500 mm² and preferably from 500 mm² to 4000 mm². The specific support preferably comprises 4 to 20 or even 6 to 20 contact zones each of relatively large area, that is to say an area each in the range from 500 mm² to 4000 mm².

A specific support of this kind can have a fixed geometry perfectly complementary to that of the first principal face of the glass with which it has to come into contact. A support of this kind may for example have crenellated support lines.

A specific support of this kind may also feature contact zones connected to supporting elements comprising mobility means of the contact zone driven by the weight of the glass at the moment of its reception by the support, modifying the orientation of the contact zone of the glass and/or damping the reception of the glass by the support. In particular:
the support element may comprise a spring damping the reception of the glass on its release by an upper forming mold; the movement of the contact zone may be guided on the axis of the spring and the support element then has only a damping function; however, the spring need not be guided on its axis and may be able to move laterally, in which case the contact zone is automatically oriented in contact with the glass to espouse the latter better;
the support element may comprise a plurality of parts each terminated by a contact zone, said parts being interconnected and able to be oriented about a pivot; when the contact zone of a part is lowered following its contact with the glass, the other part of the same support element therefore rises by pivoting about the pivot until it comes into contact with the glass; the various contact zones of a support element are therefore automatically oriented by balancing the weight of the glass about their pivot; a spring may act to push the various parts of the support element up and also to damp the reception of the glass.

According to this embodiment using a specific support touching the glass only in the “contact band” defined above, one feature of the device is that an upper forming mold able to act on the glass (taking charge of it or depositing it) over that specific support has a contact surface for the glass projecting more than 30 mm toward the exterior of the contact zones of the cooling specific support.

According to another embodiment, the specific support is an inclined peripheral track: the glass is deposited cantilever-fashion by the lower border of its edge surface (such as the lower edge of its edge surface) on the track and without contact with the lower face of the glass; the glass is therefore considered to be supported from below but without contact with its lower face and outside the peripheral zone. This support forms a continuous support surface to come into contact with the glass.

A forced convection system can accelerate cooling in the cooling chamber and/or the transfer chamber, if any; a convection system of this kind may be connected to a support or installed in one of these chambers. A convection cooling system may therefore generally be carried by a cooling specific support, a preliminary specific support or an offloading specific support. A convection cooling system may be installed in the transfer chamber, in the cooling chamber and on the final device tasked with conveying the glass to a cooling zone.

The routing of the glass between the cooling chamber and the final offloading zone where the glass is set and cooled sufficiently to be manipulated by operators and stored can be effected in various ways. In particular, an offloading support, in particular one actuated by a robot, may come below the glass, rise to take charge of the glass, and then exit the glass from the cooling chamber. It can then deposit it on a conveyor taking the glass off to a cooler offloading zone. The robot then returns with the same offloading support to take charge of the next glass in the cooling chamber. The method is therefore limited to a single offloading support connected to the robot, which avoids multiple operations of coupling and uncoupling a support and a robot. Given that at the moment the glass is taken charge of by the offloading support the glass is at a temperature close to or greater than the lower homogeneous temperature, the offloading support is advantageously of the “specific support” type (termed an “offloading specific support”) having a plurality of contact zones with the central zone of the first principal face of the glass. The cooling specific support and the offloading specific support are advantageously both of the type having a plurality of zones of contact with the central zone of the first principal face of the glass. They can therefore both come exclusively into contact in the same surface band of the first principal face of the glass, termed the “contact band” and already defined hereinabove. This is made possible by the fact that the contact zones of these two supports are discontinuous and can therefore cross over at the moment of the transfer of the glass from the cooling specific support to the offloading specific support, like the teeth of two combs. It is in fact preferably to avoid contact with the glass in its central zone more than 200 mm and preferably more than 170 mm and preferably more than 150 mm from the edge because in the method according to the invention the glass is hotter in the central zone than at the periphery and is therefore more sensitive to marks in the central zone. Moreover, this “contact band” is sufficiently peripheral for the curvature of the glass to be well maintained, without the peripheral zone collapsing. According to this embodiment, the offloading support and the cooling specific support both comprise support elements comprising contact zones that all come into contact with the glass exclusively in a contact band between an exterior limit and an interior limit, the exterior limit of the band being at least 50 mm and preferably at least 60 mm and preferably at least 70 mm from the edge of the glass, the interior limit of the band being at most 200 mm and preferably at most 170 mm and preferably at most 150 mm from the edge of the glass, the contact zones of the offloading support and of the cooling specific support being at least in part interleaved in the contact band at the moment of loading the glass onto the offloading support. The contact zones of the cooling specific support and the offloading support can therefore all come into contact with the glass exclusively in a contact and substantially parallel to the edge of the glass, said contact band being at most 150 mm wide, or even at most 100 mm wide, or even at most 80 mm wide, the contact zones of the offloading support and of the cooling specific support being at least in part interleaved in the contact band at the moment of loading the glass onto the offloading support. In particular, during the transfer of the glass, there preferably exists, seen from above and in orthogonal projection in a horizontal plane, at least one support element of the cooling support coming to intersect the straight line segment tangential to the exterior edges of two contact zones of a pair of adjacent support elements of the offloading support, that intersection occurring between the two adjacent support elements of the offloading support. This situation generally arises for at least 2 different support elements of the cooling support, or even at least 3, or even at least 4, or even at least 5, or even at least 6 different support elements of the cooling support. This property reflects the fact that the contact zones of the two supports are interleaved in a narrow contact band parallel to the edge of the glass at the moment of the transfer of the glass. The intersection may involve the contact zone of the cooling support or any part of the support element of the cooling support, between the contact zone and the chassis of the cooling support.

During transfer of the glass there may exist, seen from above and in orthogonal projection in a horizontal plane, at least one pair of adjacent support elements of one of the two supports (the cooling one or the offloading one), termed the first support, such that the straight line segment passing through the center of their contact zone comes to intersect a support element of the other support, in particular its contact zone, that intersection occurring between the two adjacent support elements (forming a pair) of the first support. This situation can arise for at least 2, or even at least 3, or even at least 4, or even at least 5 different pairs of support elements of one of the supports, it being understood that a support element may be part of two different pairs. This property also reflects the fact that the contact zones of the two supports are interleaved in a narrow contact band parallel to the edge of the glass at the moment of the transfer of the glass. The intersection may involve the contact zone or any part of the support element of the other support. The center of a contact zone is, seen from above, the barycenter of the orthogonal projection of the contact zone onto a horizontal plane. That barycenter is also the geometrical center or center of mass of the projection of the zone and might be termed the “centroid” or “geometric center”. This is the point on the surface of the projection of the zone corresponding to the barycenter of an object of the same shape, infinitely thin and of homogeneous density.

In the method according to the invention, the overall rate of cooling of the glass generally only rises between the separation of the glass from the gravity support and its exit from the cooling chamber. In the separation chamber, the mean rate of cooling of the glass is generally between 0.5 and 1.2° C. per second. In the cooling chamber, the mean rate of cooling of the glass is generally between 0.8 and 2.5° C. per second. In the transfer chamber, if any, the mean rate of cooling of the glass is generally between 0.8 and 2.5° C. per second.

The mean rate of cooling in a chamber (separation, transfer or cooling chamber) is calculated from the glass temperature difference between the moment it enters the chamber and the moment it exits the chamber, divided by the time spent in the chamber.

The glass cools even more rapidly once it has exited the cooling chamber, at a rate generally between 2 and 5° C. per second at least until the glass reaches a temperature of 400° C.

In the method according to the invention, the cycle time is generally between 10 and 60 seconds, a cycle time being the time elapsed between the passage of two glasses at the same location of the process and at the same stage thereof.

The invention enables the manufacture of a bent sheet of glass the maximum tension stress in which is less than 4 MPa and even less than 3 MPa and the edge compression stress in which is greater than 8 MPa. The passage from the compression zone to the tension zone is generally located at a distance from the edge between 1 and 5 millimeter. The maximum tension stress is generally situated at a distance from the edge between 5 and 40 millimeter, in particular between 15 and 40 millimeter. This sheet is that in the lower position in the stack of sheets that have undergone the method according to the invention. The face of this sheet, in the lower position in this stack (first principal face) is generally convex. This sheet may be placed in laminated glazing, the face that was in the lower position during the method according to the invention forming the face 1 of the glazing. It is then located on the convex side of the glazing.

The invention concerns the manufacture of laminated glazing combining two sheets of glass where the thickness of one of them is in the range from 1.4 to 3.15 mm and the thickness of the other of them is in the range from 0.5 to 3.15 mm. In the situation where the sheets have different thicknesses, the face 1 of the laminated glazing is a face of the thicker or thickest sheet.

Each sheet of glass may be covered before bending it with one or more sheets of enamel or one or more thin anti-solar (low-e) type layers, conductive layers or other layers usually applied to automobile glazing.

The bent glass manufactured in accordance with the invention relates more particularly to the manufacture of glazing, in particular laminated glazing, of the road vehicle windshield or roof type. The area of one of their principal surfaces is generally greater than 0.5 m², in particular between 0.5 and 4 m². There may generally be placed in the central region of the glass an imaginary circle with a diameter of least 100 mm and even of at least 200 mm and even of at least 300 mm, all points on which are farther than 200 mm from all the edges of the glass, which characterizes a certain magnitude of the glass. The glass generally has four edges (also termed bands), the distance between two opposite edges generally being greater than 500 mm and more generally greater than 600 mm and more generally greater than 900 mm.

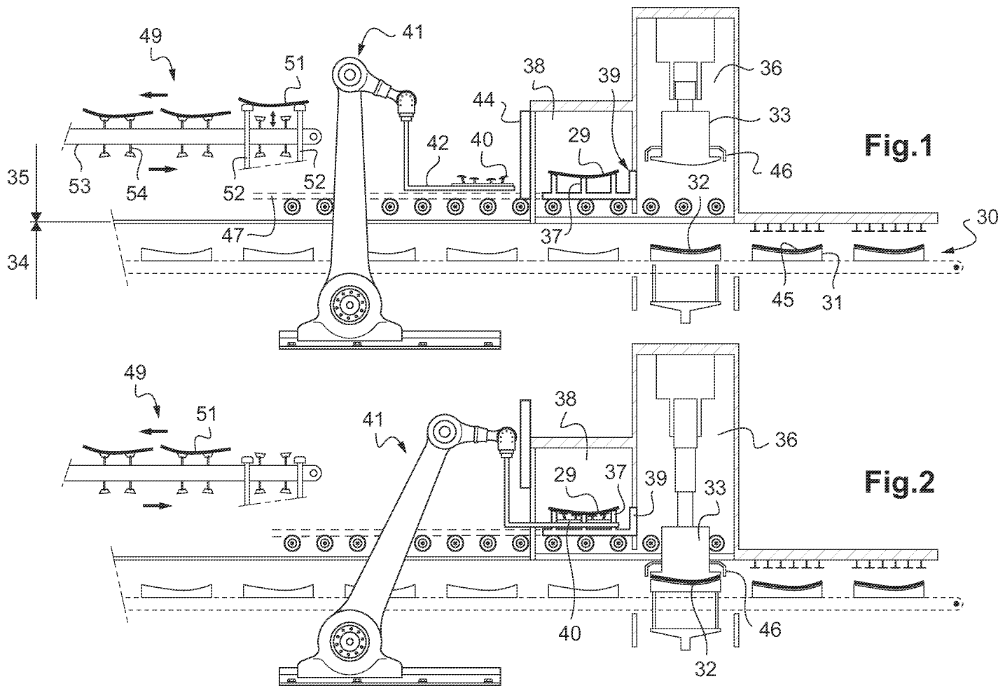

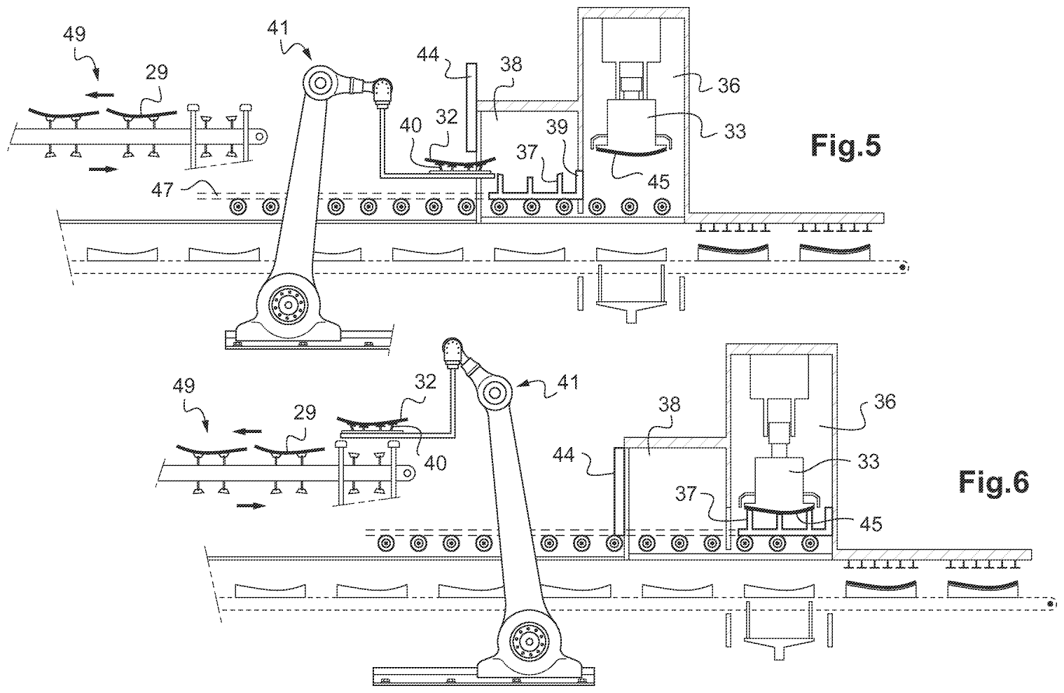

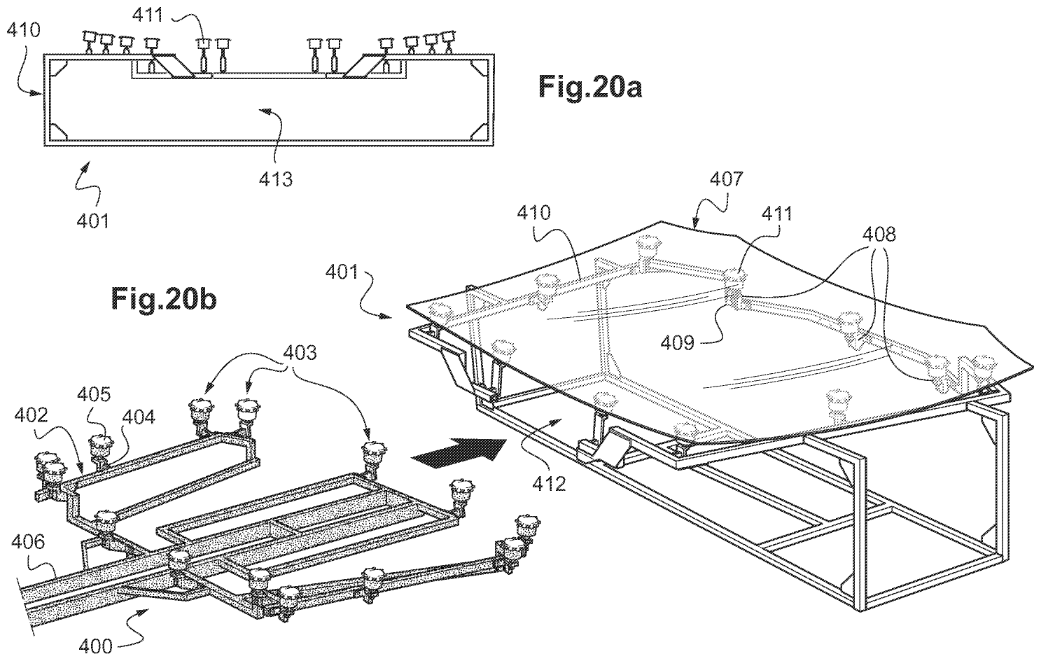

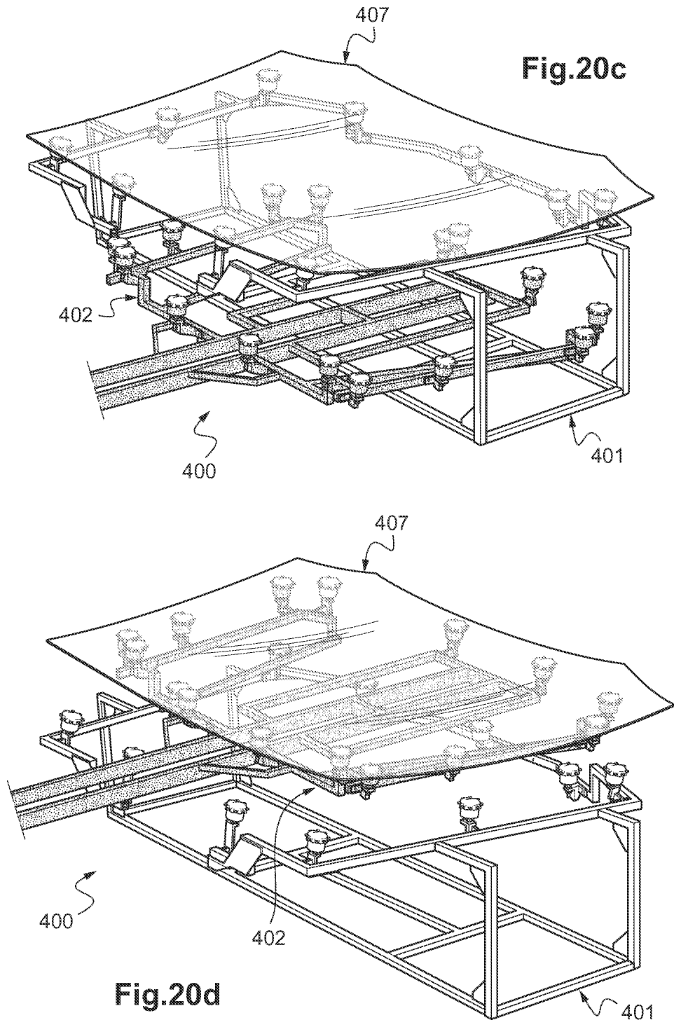

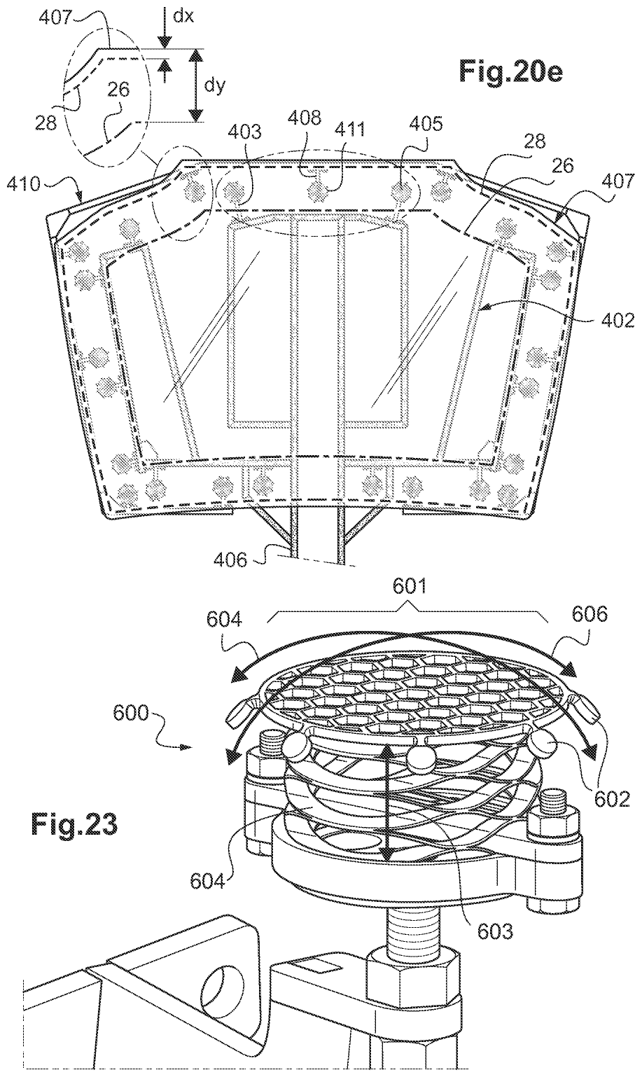

FIGS. 1 to 6 show a device according to the invention at various stages of the treatment of glass moving one behind the other. Here the glass is bent only by gravity. In FIG. 1, the glass is conveyed from right to left and undergoes bending by gravity. This device comprises a train 30 of gravity supports 31 each carrying a glass 32. This train circulates at a lower level 34 of the device, in a tunnel furnace heated to the plastic deformation temperature of the glass. As it is conveyed, the glass sags under its own weight until it finally espouses the track of the gravity support 31 under the periphery of the first principle face of the glass. Each support carrying a glass arrives under a vertically mobile upper forming mold 33 able to pass from the upper level 35 to the lower level 34 and vice versa. This upper forming mold 33 is in a separation chamber 36 the atmosphere in which is at a temperature between 540 and 580° C. This upper forming mold 33 comes into contact with the glass only at the periphery of its second principal face. The contact track of this upper forming mold 33 has a shape complementary to that of the gravity supports 31. The upper forming mold 33 can take charge of the glass at the lower level 34 by suction thanks to a skirt 46 surrounding it. At the upper level 35 is the laterally mobile cooling specific support 37 shuttling between a position under the upper forming mold 33 in the chamber 36 and a cooling chamber 38 heated to a temperature between 400 and 565° C. A system of chains 47 enables lateral movement of the cooling specific support between the chambers 36 and 38. There is a door 39 on the structure carrying the cooling specific support and it therefore moves with the latter. This door therefore closes the partition between the chambers 36 and 38 when the cooling specific support is in the chamber 38. When it is in the chamber 36, this door is against the right hand bulkhead of the chamber 36 as seen in the figure. Instead of being on the support 37, a vertically mobile door could have been installed on the wall separating the chambers 36 and 38 and, provided with sides and a raising and lower system, provide the isolation function required between the chambers 36 and 38. The glass may be offloaded from the specific support 37 by an offloading support 40 carried by an arm 42 of a robot 41. To this end, the offloading support 40 is engaged under the glass still being carried by the specific support 37, rises and takes charge of the glass as it rises, after which it exits the chamber 38 carrying the glass. The robot 41 then drives the offloading support 40 carrying the glass toward a final device 49 tasked with taking charge of the glass to convey it to a cooling zone enabling offloading and storage of the glass. The cooling specific support 37 is of the type from FIG. 20a referenced 401. The offloading support 40 is of the type from FIG. 20b referenced 400. In FIG. 1 the glass 32 arrives under the upper forming mold 33, the train then stopping. The robot has previously already offloaded a glass 51 onto the final device and more specifically onto four vertically mobile bars 52. A conveyor 53 circulates between the bars 52. This conveyor drives the supporting elements 54 (for example suckers) able to receive the glass when the bars 52 are lowered. The glass then rests on support elements 54 and is driven by the conveyor 53 toward a cooling zone in which it is offloaded and then stored. The device 49 is not shown in the other FIGS. 2 to 6 to simplify the representation. FIG. 2 represents a stage after that from FIG. 1. In FIG. 2, the upper forming mold 33 descends as far as the glass 32 to take charge of it. During this time the robot 41 engages its offloading support 40 under the cooling specific support 37 and then rises to take charge of the preceding glass 29. The forming mold 33 rises with the glass 32, after which the empty cooling specific support 37 passes from the chamber 38 to the chamber 36. The upper forming mold 33 is lowered, releases the glass 32 onto the cooling specific support 37 and rises again (FIG. 3). Simultaneously, the train 30 of gravity supports 31 has advanced one step to the left, therefore bringing the next glass 45 under the upper forming mold 33. During this time, the preceding glass 29 has exited the chamber 38 and the robot 41 places it on the conveyor 49 to continue its cooling. The support 37 carrying the glass 32 then enters the chamber 38. In parallel with this another glass 45 is taken charge of by the upper forming mold 33 which is lowered as far as the train of gravity supports 30 at the lower level 34. The door 44 is raised and the robot 41 engages the offloading support 40 under the cooling specific support 37 (FIG. 4). The robot raises the offloading support 40 so that the latter takes charge of the glass 32. In parallel with this, the upper forming mold 33 rises with the glass 45 in the chamber 36 (FIG. 5). The robot then exits the support 40 carrying the glass 32 from the chamber 38, after which the door 44 descends again. In parallel with this, the cooling specific support 37 has passed from the chamber 38 to the chamber 36 and the forming mold 33 has been lowered to release the glass 45 onto the support 37 (FIG. 6). The robot then places the glass 32 on the device 49, which then drives it toward the final cooling zone. The glass 45 then undergoes the same treatment as that undergone by the glass 32. The temperature homogenization of the peripheral zone of the first principal face of the glass begins as soon as the glass is separated from the bending support 31. The peripheral zone of the first principal face of the glass is then free of all contact whereas the glass is held by the upper forming mold 33 and then supported by the cooling specific support 37 and then the offloading support 40.

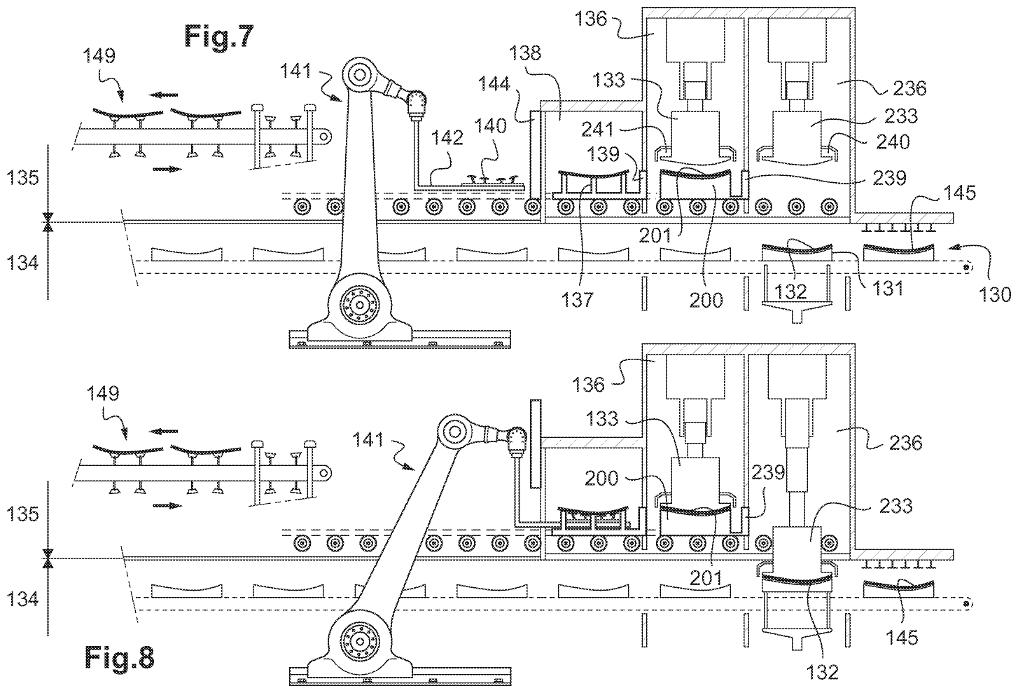

FIGS. 7 to 13 show a method and a device according to the invention at various stages of the treatment of glass fed one after the other. Compared to the preceding device from FIGS. 1 to 6, the glass undergoes a step of bending by suction between bending by gravity on a gravity support and being placed on the cooling specific support. The process undergone by the glass in the context of this variant is described hereinafter.

The device comprises a train 130 of gravity supports 131 each carrying a glass. This train circulates at a lower level 134 of the device, in a tunnel furnace heated to the plastic deformation temperature of the glass. During its conveyance (from right to left in the figures), the glass sags under its own weight finally to espouse the contact track of the gravity support 131 under the periphery of the first principal face of the glass. Each support finally arrives under a vertically mobile upper forming mold 233 able to pass from the upper level 135 to the lower level 134 and vice versa. This upper forming mold 233 is in a chamber 236 the atmosphere in which is at a temperature between 550 and 590° C. The contact track of this upper forming mold 233 has a shape complementary to that of the suction mold 200. The upper forming mold 233 can take charge of the glass at the lower level 134 by suction thanks to the skirt 240 surrounding it. At the upper level 135 is located a suction lower mold 200 the face 201 of which in contact with the glass is solid and includes orifices in order to communicate vacuum to the first principal face of the glass in the lower position. This mold 200 shuttles between a position under the upper forming mold 233 in the chamber 236 and a juxtaposed chamber 136 heated to a temperature between 500 and 560° C. This chamber 136 contains a vertically mobile upper forming mold 133 able to take charge of the glass thanks to a skirt 241. At the upper level 135 is also located a laterally mobile cooling specific support 137 shuttling between a position under the upper forming mold 133 in the chamber 136 and a position in the cooling chamber 138, the temperature in which is between 350 and 520° C. A door 139 on the structure carrying the cooling specific support 137 therefore moves with it. This door therefore closes the bulkhead between the chambers 136 and 138 when the cooling specific support is in the chamber 138. It closes the bulkhead between the chambers 136 and 236 when the cooling specific support 137 is in the chamber 136. A door 239 on the structure carrying the suction lower mold 200 therefore moves with it. This door 239 therefore closes the bulkhead between the chambers 136 and 236 when the suction lower mold 200 is in the chamber 136. The support 137 and the mold 200 move simultaneously in translation, as if they were fastened to one another and without modification of the distance that separates them. The glass is offloaded from the cooling specific support 137 by the offloading support 140 held by the arm 142 of a robot 141. The cooling specific support 137 is of the type from FIG. 20a referenced 401. The offloading support 140 is of the type from FIG. 20b referenced 400.

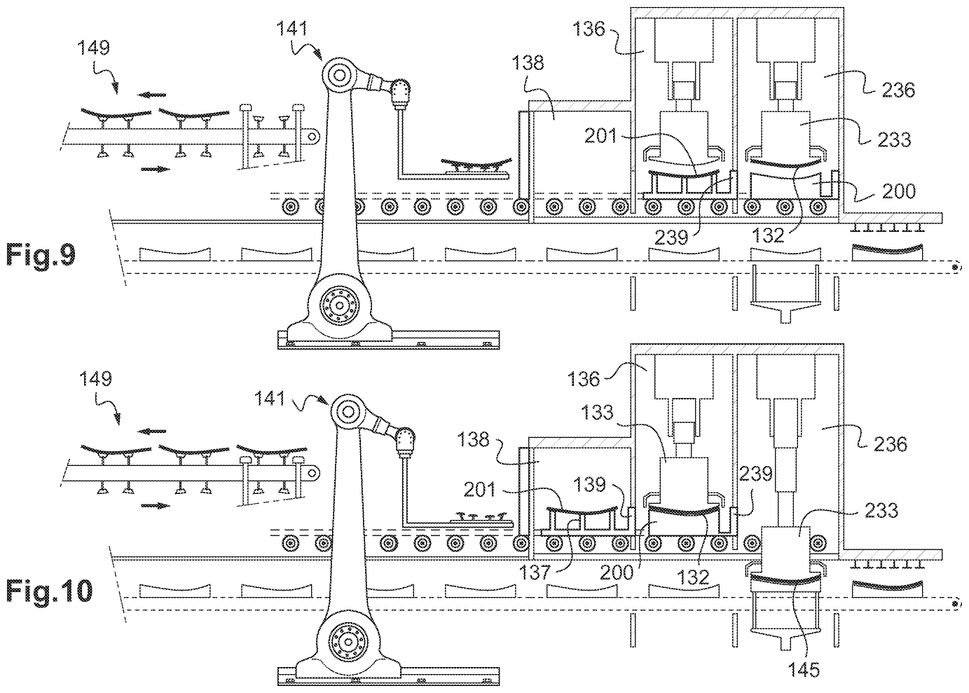

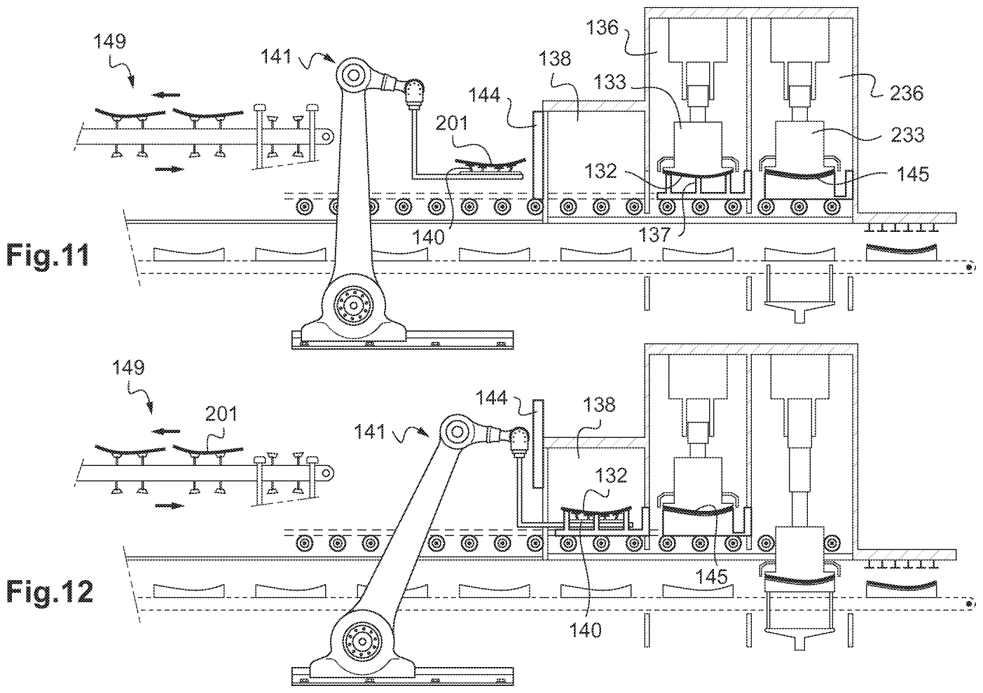

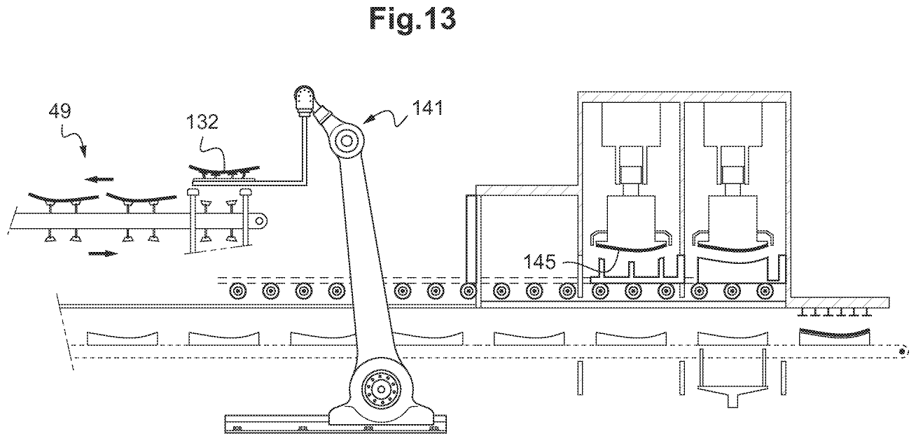

In FIG. 7, the glass 132 arrives under the upper forming mold 233, the train 130 then stopping. The upper forming mold 233 descends as far as the glass 132 to take charge of it (FIG. 8). This forming mold rises with the glass, after which the empty (with no glass) suction lower mold 200 passes from the chamber 136 to the chamber 236, and likewise the cooling specific support 137 passes empty from the chamber 138 to the chamber 136 (FIG. 9). The upper forming mold 233 is lowered with the glass, and then presses lightly on its periphery in order to seal the periphery of the glass between the glass and the mold 200 on the one hand and between the various sheets of the stack. The suction by the skirt of the forming mold 233 is stopped simultaneously with this pressing. The suction of the suction lower mold is triggered when this light pressing has already begun. The glass is then bent on the suction lower mold and all the sheets of the stack simultaneously undergo bending because of the pressure exerted at the periphery, the vacuum being communicated from one sheet to the other. The forming mold 233 rises again, leaving the glass on the mold 200. The mold 200 carrying the glass 132 enters the chamber 136 under the upper forming mold 133. The suction exerted by the mold 200 is stopped when the bending is finished, which generally occurs in the chamber 236 just before the upper forming mold 233 is raised. In the meantime, the train 130 of gravity supports 131 has advanced one step to the left, therefore bringing the glass 145 under the upper forming mold 233. The upper forming mold 133 is lowered (FIG. 10) to take charge of the glass 132 and rises with it. In parallel with this, the upper forming mold 233 is lowered also to take charge of the next glass 145. The support 137 passes empty from the chamber 138 to the chamber 136 and the mold 200 passes simultaneously from the chamber 136 to the chamber 236. The upper forming mold 133 releases the glass 132 onto the cooling specific support 137 and the upper forming mold 233 is lowered to press the glass 145 against the mold 200 (FIG. 11), as already described for the glass 132 (the treatment of the glass 145, which is identical to that of the glass 132, is not described further). The support 137 carrying the glass 132 enters the chamber 138. The door 144 is raised and the robot 141 engages the offloading support 140 under the cooling specific support 137 (FIG. 12). The robot then causes the offloading support 140 to rise for the latter to take charge of the glass 132. The robot then exits the offloading support 140 carrying the glass 132 from the chamber 138 and the door 144 descends again. The robot then places the glass 132 on a final device 49 identical to that already described for FIGS. 1 to 6, for continued cooling (FIG. 13).

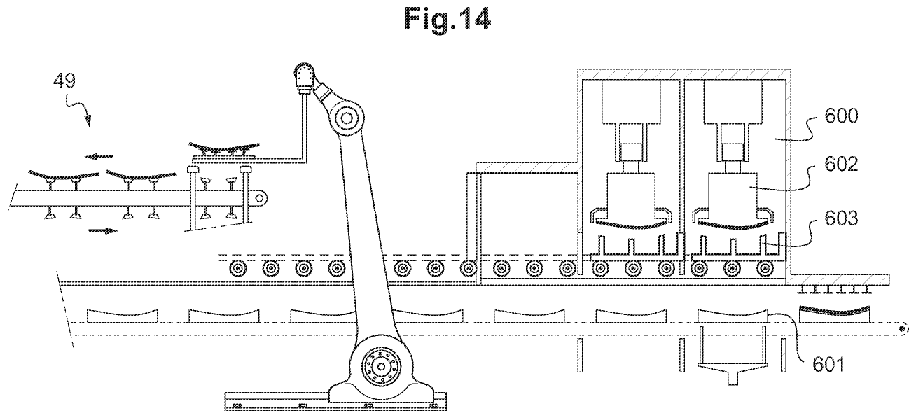

FIG. 14 shows a device identical to that of FIGS. 7 to 13 except that the suction lower mold is replaced by a preliminary specific support 603. The movement of the various elements of this device is identical to that from FIGS. 7 to 13, from the gravity support 601 as far as the final device 49. However, here the glass reaches its final shape on its gravity support 601 under the separation chamber 600. Another difference compared to the system from FIGS. 7 to 13 is that the glass is not lightly pressed at the periphery against the forming mold 602 and the preliminary specific support 603. The glass is simply released by the forming mold 602 onto the support 603.

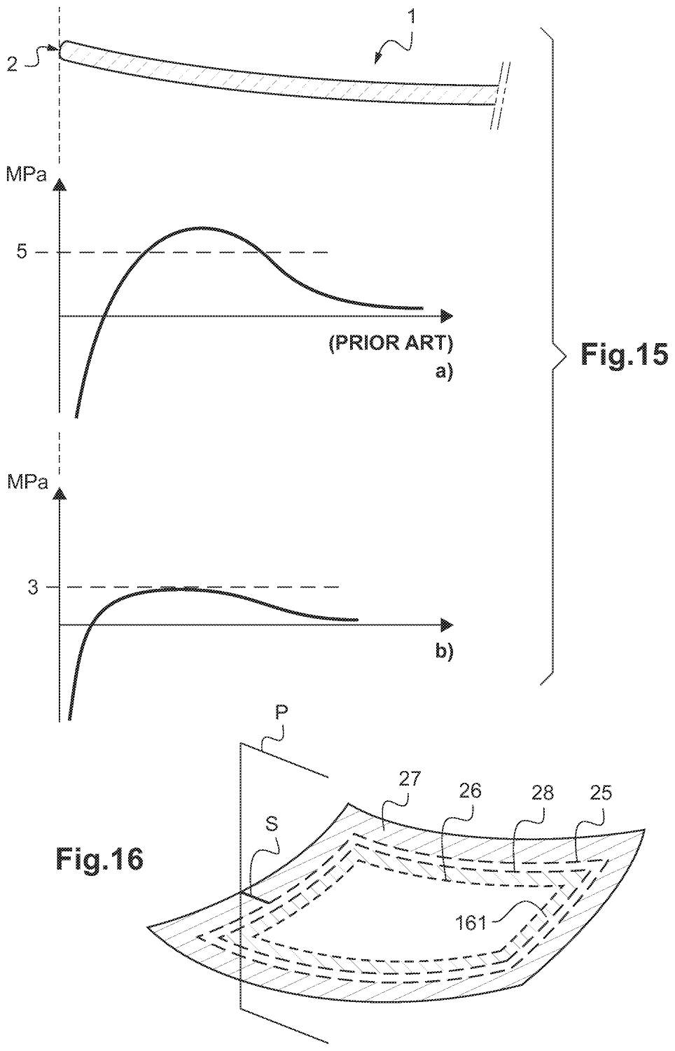

FIG. 15 shows the evolution of the stresses at the edges of a sheet of glass 1 in the direction away from the edge 2 toward the center of the sheet, at a) for a sheet conventionally obtained in accordance with the prior art and at b) for a sheet obtained in accordance with the present invention. The distance from the edge is plotted on the abscissa axis and the stresses in the glass on the ordinate axis. The stresses below the abscissa axis are compression stresses. Those above the abscissa axis are tension stresses. According to the prior art (a), the tension stresses usually exceed 5 MPa, which is high. According to the invention, the maximum tension stress may be only 3 MPa which is very favorable to the mechanical strength of the sheet, compared to case a).

FIG. 16 represents the lower face of a bent sheet of glass. The dashed line 25 is located 50 mm from the edge of the sheet and indicates the end of the peripheral zone. The line 28 indicates the exterior limit of the contact band for the contact zones of the specific supports. This exterior limit may coincide with the line 25 or preferably come to within at least 60 mm and even 70 mm from the edge. The line 26 indicates the interior limit of the contact band for the contact zones of the specific supports. The cross-hatched zone 27 between the edge of the glass and the line 25 is the peripheral zone. The plane P is an imaginary plane perpendicular to the edge of the glass and to the sheet. The intersection of the plane P with the lower face defines a segment S. According to the invention, the temperature is homogenized over the 50 mm of this segment starting from the edge of the sheet. The specific supports coming into contact with the glass in the critical temperature range preferably touch the glass in the zone 161 and without coming into contact with the glass outside the zone 161.

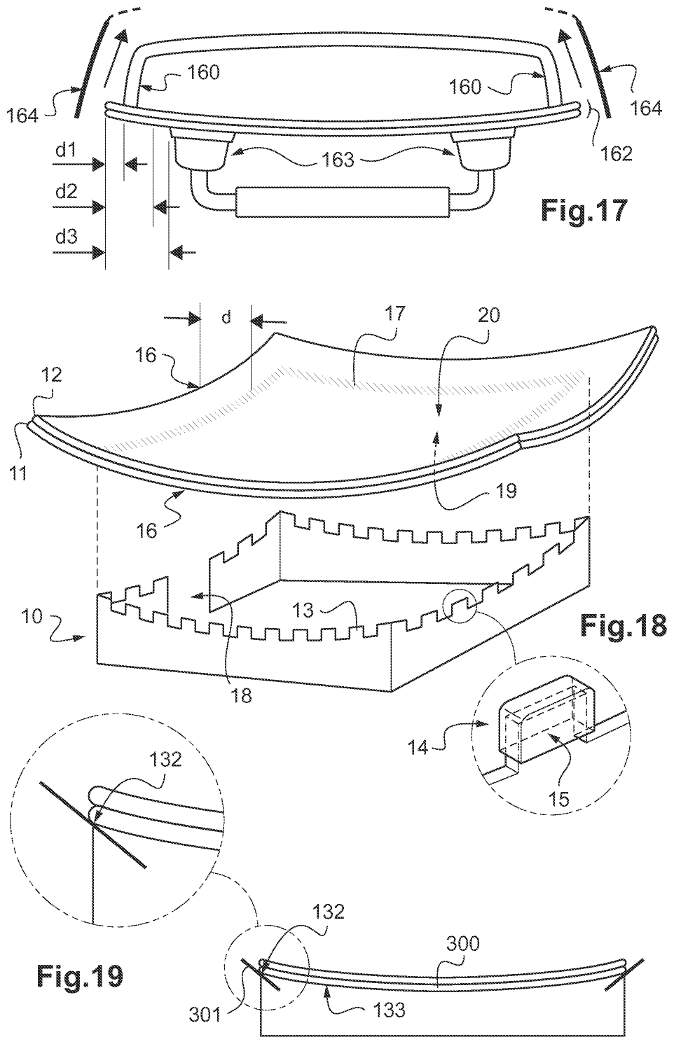

FIG. 17 represents the respective positions of a frame-shaped upper forming mold 160, a glass 162 and a specific support 163 of the type coming into contact with the glass in the central zone (inside the interior limit of the peripheral zone). This situation can arise when the upper forming mold takes charge of the glass initially on the specific support or the upper forming mold releases the glass onto the specific support. The glass is taken charge of following the initiation of suction between the skirt 164 and the upper forming mold 160. The upper forming mold 160 comes into contact with the second principal face of the glass with the result that its exterior edge 164 arrives at a distance dl from the edge of the glass in the range from 3 to 20 mm. The distance d2 corresponds to the peripheral zone. The distance d3 is the distance between the exterior edge of the contact zone of the specific support 163 and the edge of the glass. The distance between the exterior edge of the upper forming mold and the exterior edge of the contact zone of the specific support is d3-d1, which is greater than 30 mm.

FIG. 18 shows a cooling specific support 10 able to receive the glass (here a stack of two sheets of glass 11 and 12 one on the other) without contact with the peripheral zone of its downward-facing first principal face 19. This support offers to the glass a shape complementary to that which it receives through bending. This support comprises a multiplicity of aligned crenellations 13. The upper face 14 of each crenellation is designed to receive the first principal face 19 of the glass in the “contact band” in the central zone of the glass. To soften the contact of a tool with the hot glass each crenellation 13 is covered with a refractory fiber fibrous material 15 well known to the person skilled in the art. The contact zone formed by the upper faces of the crenellations (represented by the cross-hatched zone 17 in the figure) comes into contact with the glass at a distance d greater than 50 mm from the edge 16 of the glass around the entire periphery of the glass. This support 10 is a frame one side of which includes a passage 18 to allow passage of the arm of an offloading support that comes to take charge of the glass from below.

FIG. 19 represents a cooling specific support 301 of the peripheral track type carrying a stack of two sheets of glass. The glass 300 rests cantilever-fashion via the lower intersection line 132 of its edge surface on the peripheral track. The glass therefore has no contact with the support in the peripheral zone of its first principal face 133, enabling the homogenization in accordance with the invention to be produced and preserved.

FIG. 20 shows how an offloading support can take charge of a glass when the latter is carried by a cooling specific support 401. This glass intended for a windshield comprises four bands. At a) is seen from the side the empty cooling specific support 401 with its support elements 411. Its chassis 410 provides a free space 413 allowing the offloading support 400 to penetrate to the interior of the chassis 410 under the glass (not shown at a)). FIGS. 20b to 20d show sequentially the passage of a glass 407 from a cooling specific support 401 to an offloading support 400. At b), the empty offloading support 400 is manipulated by a robot (not shown) actuating the arm 406. It approaches the cooling specific support 401 carrying a glass 407. The offloading support comprises a chassis 402 carrying a plurality of support elements 403. These support elements 403 are connected by one end 404 to the chassis 402 and have at their other end 405 a contact zone that comes into contact with the glass. Seen from above, the support elements 403 are directed toward the exterior of the chassis 402 in the direction from the end 404 to the end 405. At b) the cooling specific support 401 carries a glass 407 by means of a plurality of support elements 408. This cooling specific support 401 comprises a chassis 410 and a plurality of support elements 408. These support elements 408 are connected by one end 409 to the chassis 410 and have at their other end 411 a contact zone that comes into contact with the glass. Seen from above, the support elements 408 are directed toward the interior of the chassis 410 in the direction from the end 409 to the end 411. The chassis 401 comprises a passage 412 to enable the support 400 to rise (see phase c)) without immobilizing it. At c), the offloading support 400 has been placed under the glass as yet without touching it. At d), the offloading support 400, actuated by the robot, has risen and has taken charge of the glass 407, offloaded from the cooling specific support 401. This is made possible thanks to the passage 412 in the chassis 401 allowing the arm 406 of the offloading support 400 to pass and thanks to the fact that the support elements 403 and 408 are offset as seen from above, the support elements 403 extending toward the exterior whereas the support elements 408 extend toward the interior. Accordingly, when the support 400 rises, the support elements 403 on the one hand and the support elements 408 on the other hand cross in the manner of the teeth of two combs. Thus the contact zones of the two supports 400 and 401 can both come into contact with the glass in the same “contact band” (between 50, or even 60, or even 70 mm from the edge of the glass and 200 or even 170 mm or even 150 mm from the edge of the glass) as defined above, without contacting the glass outside this band. The support elements 403 and 408 preferably have their contact zone adapted to the shape of the glass that they receive, that is to say their contact zone is oriented toward the glass and is therefore substantially parallel to the zone of the glass received. The support elements may moreover comprise a spring to damp the reception of the glass at the moment it is taken charge of. In FIG. 20e, there are seen from above and in orthogonal projection in a horizontal plane the two supports at the moment of the transfer of the glass 407 from the cooling specific support to the offloading specific support. It is seen that the contact zones of the two supports 405 and 411 all come into the “contact band” between the line 26 (interior limit of the contact band at the distance dy from the edge, dy being at most 200 or even at most 170 mm or even at most 150 mm) and the line 28 (exterior limit of the contact band at the distance dx from the edge with dx being at most 50 or even at most 60 or even at most 70 mm). This contact band is therefore at most 150 mm wide (200−50=150) or even at most 100 mm wide (170−70=100) or at most 80 mm wide (150−70=80). Moreover, the contact zones of the offloading support and of the cooling specific support are at least in part interleaved in the contact band. At the moment of the transfer of the glass from one support to the other at least one contact zone of a support has for its immediate neighbors two contact zones of the other support. It is seen that at the moment of the transfer of the glass the straight line 414 tangential to the exterior edges of two contact zones 415 and 416 of two adjacent support elements of the offloading support come to intersect a support element 417 of the cooling support. This actuation occurs for a plurality of support elements of the cooling support. It is also seen that the straight line segment passing through the centers 418 and 419 of the contact zones 415 and 416 of two adjacent support elements of the offloading support come to intersect the support element 417 of the cooling support. This situation occurs for a plurality of support elements of the cooling support. This reflects the fact that the contact zones of the two supports are interleaved in a narrow band parallel to the edge of the glass. It is seen that when dy is equal to 200 mm the central region of the lens situated inside the line 26 (zone of the glass farther than 200 mm from the edge) can easily contain an imaginary circle of 100 mm diameter and even of 200 mm diameter and even larger (for example 500 mm or even 1000 mm in diameter), not touching the line 26. This property reflects the size of the principal faces of the glass.

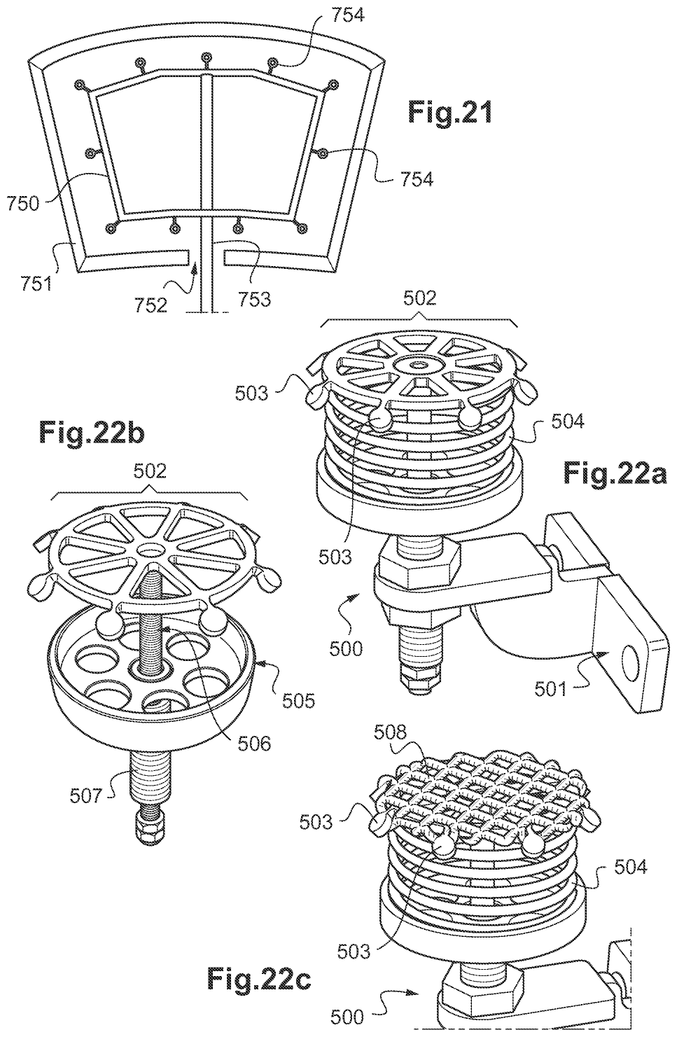

FIG. 21 shows how an offloading specific support 750 can come to take charge of a glass (not shown) initially supported by a track type cooling specific support 751. This track forms, seen from above, an interrupted frame because it comprises a passage 752 enabling an arm 753 connected to the offloading support 750 to pass through it by a vertical movement. The support 750 therefore comes underneath, rises, takes charge of the glass initially supported by the support 751 and can move the glass on to the next step. The support 750 carries the glass by means of support elements 754.

FIGS. 22 and 23 show support elements that can equip a cooling specific support or an offloading support. In FIG. 22a, the support element 500 comprises at one of its ends a base 501 provided with orifices enabling it to be fixed to a chassis. The other end comprises a contact zone 502 covered with a fibrous material 508 to come into contact with the glass. The open texture fibrous material 508 is retained on the surface of the element by lugs 503. The contact zone 502 is mobile in translation in a direction that is perpendicular to it and its downward movement is accompanied by the compression of a spring 504. The reception of a glass by a contact zone 502 is therefore damped by the spring 504. In FIG. 22b is seen the same support element as in FIG. 22a except that the spring 504 has been removed as well as the part comprising the base 501. It is seen in this figure b) that a cup 505 is able to receive the spring 504. It is also seen that the rod 506 is guided in the tube 507 so that the contact zone 502 can move only in a direction corresponding to the axis of the tubular guide 507. Figure c) shows the support element the contact zone of which is fitted with its knitted type open texture refractory fibrous material 508 to come into contact with the glass.

FIG. 23 shows another support element provided with a contact zone 601 surrounded by lugs 602 enabling the retention of a perforated refractory material (not shown) on the surface of the contact zone. Compared to the element from FIG. 22, there is no guide obliging the contact zone to retain its orientation. This absence of a guide confers a supplementary degree of freedom on the contact zone, which can not only move parallel to the axis of the spring 604 (arrow 603) but also turn so that the perpendicular to the contact zone moves away from the axis of the spring 604 (arrow 605 or 606). This faculty of being orientable is exploited when an element of this kind receives a glass where the local orientation of the surface does not correspond exactly to that of the contact zone. In this case, because of the weight of the glass, the contact zone 601 is automatically oriented to take exactly the orientation of the surface of the glass. Such behavior confers on the support comprising such support elements a more universal character in that the same support can adapt to different shapes of glass.

1. A method of bending and of cooling a sheet of glass or a stack of sheets of glass, comprising a first principal face and a second principal face, said method comprising bending the glass by gravity on a gravity support during which the glass rests on the gravity support in a peripheral zone of the first principal face, said peripheral zone being constituted of 50 mm from an edge of the first principal face, then separating the glass from the gravity support, then cooling the glass during which the first principal face is free of any contact in the peripheral zone, in a critical temperature range that is between an upper homogeneous temperature, of at least 560° C., and a lower homogeneous temperature, of at most 500° C., a zone of the first principal face at a distance greater than 200 mm from the edge being at a temperature at least equal to that of the peripheral zone at the moment when the peripheral zone reaches the upper homogeneous temperature.

2. The method as claimed in claim 1, wherein the upper homogeneous temperature is at least 575° C.

3. The method as claimed in claim 2, wherein the lower homogeneous temperature is at most 490° C.

4. The method as claimed in claim 1, wherein during cooling of the glass in the critical temperature range the first principal face of the glass is free of any contact in the 60 mm from the edge.

5. The method as claimed in claim 1, wherein before reaching the upper homogeneous temperature the first principal face is free of any contact for a time that corresponds to a temperature homogenization time of at least 5 seconds.

6. The method as claimed in claim 5, wherein during the temperature homogenization time the glass is held by the second principal face against an upper forming mold provided with suction, the suction producing the force holding the glass against the forming mold.

7. The method as claimed in claim 1, wherein at the moment of separation a zone of the first principal face farther from 50 mm from the edge of the glass is at a temperature higher than that of the peripheral zone.

8. The method as claimed in claim 1, wherein at the moment of reaching the upper homogeneous temperature a zone of the first principal face farther than 50 mm from the edge of the glass is at a temperature at least equal to that of the peripheral zone.

9. The method as claimed in claim 1, wherein the peripheral zone of the first principal face is homogeneous in temperature on any line of intersection of a section perpendicular to the edge of the glass between the upper homogeneous temperature and the lower homogeneous temperature.

10. The method as claimed in claim 1, wherein the glass is supported in at least a part of the critical temperature range by at least one specific support without contact with the peripheral zone of the first principal face.

11. The method as claimed in claim 10, wherein the specific support comprises a plurality of contact zones coming into contact with the first principal face of the glass exclusively at least 50 mm from the edge of the glass.

12. The method as claimed in claim 10, wherein the specific support comprises a plurality of contact zones coming into contact with the first principal face of the glass exclusively at most 200 mm from the edge of the glass.

13. The method as claimed in claim 10, wherein the specific support comprises an inclined track supporting the glass by the lower border of its edge surface.

14. The method as claimed in claim 1, wherein the glass is held in at least a part of the critical temperature range by its second principal face by at least one upper forming mold provided with suction.

15. The method as claimed in claim 10, wherein throughout the critical temperature range the glass is either supported by at least one specific support or held by the second principal face by at least one upper forming mold provided with suction.

16. The method as claimed in claim 1, wherein the gravity support carrying the glass is positioned under a separation upper forming mold provided with suction enabling the glass to be held against it by the second principal face, after which the glass is separated from the gravity support by the separation upper forming mold and held by the separation upper forming mold in a separation chamber at a temperature lower than the temperature of the glass on the gravity support at the moment of separation, after which a cooling specific support able to support the glass without contact with the peripheral zone of its first principal face, being mobile laterally and able to enter or exit the separation chamber, is positioned under the glass and the separation upper forming mold releases the glass onto it, after which the cooling specific support carrying the glass exits the separation chamber for continued cooling of the glass.

17. The method as claimed in claim 16, wherein for continued cooling of the glass the cooling specific support carrying the glass enters the cooling chamber heated to a temperature lower than the temperature of the separation chamber, the cooling chamber being able to be at a temperature between 400 and 565° C.

18. The method as claimed in claim 1, wherein the gravity support carrying the glass is positioned under a separation upper forming mold provided with suction enabling the glass to be held against by the second principal face, after which the glass is separated from the gravity support by the separation upper forming mold and held against the separation upper forming mold in a separation chamber at a temperature lower than the temperature of the glass on the gravity support at the moment of separation, after which a preliminary specific support able to support the glass without contact with the peripheral zone of its first principal face, mobile laterally and able to enter or exit the separation chamber is positioned under the glass, after which the separation upper forming mold releases the glass onto it, after which the preliminary specific support carrying the glass exits the separation chamber and enters a transfer chamber equipped with a transfer upper forming mold provided with suction enabling the glass to be held against it by its second principal face, the temperature of the transfer chamber being lower than the temperature of the separation chamber, after which the glass is separated from the preliminary specific support by the transfer upper forming mold, after which a cooling specific support able to support the glass without contact with the peripheral zone of the first principal face, is positioned under the glass and the transfer upper forming mold releases the glass onto it, after which the cooling specific support carrying the glass exits the transfer chamber for continued cooling of the glass.

19. The method as claimed in claim 1, wherein the gravity support carrying the glass is positioned under a separation upper forming mold provided with suction enabling the glass to be held against it by the second principal face, after which the glass is separated from the gravity support by the separation upper forming mold and held against the separation upper forming mold in a separation chamber at a temperature lower than the temperature of the glass on the gravity support at the moment of separation, after which a bending suction lower mold able to bend the glass by suction on its first principal face, mobile laterally and able to enter or exit the separation chamber is positioned under the glass, after which the separation upper forming mold releases the glass onto it, after which the bending suction lower mold carrying the glass exits the separation chamber and enters a transfer chamber equipped with a transfer upper forming mold provided with suction means enabling the glass to be held against it by its second principal face, the temperature of the transfer chamber being lower than that of the separation chamber, the glass being bent on the suction lower mold in the separation chamber and/or the transfer chamber, after which the glass is separated from the suction lower mold by the transfer upper forming mold, after which a cooling specific support able to support the glass without contact with the peripheral zone of its first principal face is positioned under the glass and the transfer upper forming mold releases the glass onto it, after which the cooling specific support carrying the glass exits the transfer chamber for continued cooling of the glass.

20. The method as claimed in claim 18, wherein for continued cooling of the glass the cooling specific support carrying the glass enters a cooling chamber heated to a temperature lower than the temperature of the transfer chamber, the cooling chamber being able to be at a temperature between 350 and 520° C.

21. The method as claimed in claim 17, wherein a mean rate of cooling of the glass in the cooling chamber is between 0.8 and 2.5° C./s.

22. The method as claimed in claim 17, wherein an offloading support able to enter into contact with the first principal face of the glass without contact with the peripheral zone, enters the cooling chamber, passes under the glass and then rises to take charge of the glass and offload the glass from the cooling specific support, and then exits the glass from the cooling chamber, after which the glass is cooled to room temperature.

23. The method as claimed in claim 22, wherein the offloading support and the cooling specific support both comprise support elements comprising contact zones all of which come into contact with the glass exclusively in a contact band between an exterior limit and an interior limit, the exterior limit of the band being at least 50 mm from the edge of the glass, the interior limit of the band being at most 200 mm from the edge of the glass, contact areas of the offloading support and the cooling specific support being at least in part interleaved in the contact band at the moment of loading the glass onto the offloading support.

24. The method as claimed in claim 16, wherein a train of gravity supports each loaded with glass passes under the separation upper forming mold, the latter taking charge of the glass from each of the gravity supports one after the other.

25. The method as claimed in claim 1, wherein bending on the gravity support occurs at more than 590° C.

26. A device for bending and cooling glass in the form of a sheet or a stack of sheets, comprising a first principal face and a second principal face, the device comprising a gravity support able to bend the glass at its plastic deformation temperature while supporting the glass in a peripheral zone constituted of the 50 mm of the first principal face from the edge, a cooling specific support without contact with the peripheral zone, and a separation and transfer mechanism adapted to separate the glass from the gravity support and release the glass onto the cooling specific support, said separation and transfer mechanism comprising a separation upper forming mold provided with suction enabling the glass to be held against it by the second principal face, said separation upper forming mold being able to take charge of the glass and offload the glass from the gravity support.

27. The device as claimed in claim 26, wherein the separation and transfer mechanism comprises a separation chamber comprising the separation upper forming mold, the gravity support being mobile laterally and able to be positioned under the separation upper forming mold, the gravity support and the separation upper forming mold being able to be moved toward one another or away from one another so that the separation upper forming mold is adapted to take charge of the glass and offload the glass from the gravity support and then be moved away from the latter by rising in the separation chamber with the glass, the cooling specific support being mobile laterally and able to be positioned under the separation upper forming mold or to be moved away from that position, the cooling specific support and the separation upper forming mold being able to be moved toward one another or away from one another so that the separation upper forming mold is adapted to release the glass onto the cooling specific support.

28. The device as claimed in claim 26, wherein the separation and transfer mechanism comprises
a separation chamber comprising the separation upper forming mold,
a transfer chamber comprising a transfer upper forming mold provided with suction enabling the glass to be held against it by the second principal face,
a preliminary specific support able to support the glass without contact with the peripheral zone of its principal face,
the gravity support being mobile laterally and able to be positioned under the separation upper forming mold, the gravity support and the separation upper forming mold being able to be moved toward one another or away from one another so that the separation upper forming mold is adapted to take charge of the glass and offload the glass from the gravity support and then be moved away from the latter,
the preliminary specific support being mobile laterally and able to enter the separation chamber, to be positioned under the separation upper forming mold, the preliminary specific support and the separation upper forming mold being able to be moved toward one another or away from one another so that the separation upper forming mold is adapted to release the glass onto the preliminary specific support and then be moved away from the latter,
the preliminary specific support being able to exit the separation chamber loaded with the glass and to enter the transfer chamber and to be positioned under the transfer upper forming mold,
the preliminary specific support and the transfer upper forming mold being able to be moved toward one another or away from one another so that the transfer upper forming mold is adapted to take charge of the glass and offload the glass from the preliminary specific support and then be moved away from the latter,
the cooling specific support being mobile laterally and able to enter or exit the transfer chamber and to be positioned under the transfer upper forming mold or to be moved away from that position, the cooling specific support and the transfer upper forming mold being able to be moved toward one another or away from one another so that the transfer upper forming mold is adapted to release the glass onto the cooling specific support.

29. The device as claimed in claim 26, wherein the separation and transfer mechanism comprises
a separation chamber comprising the separation upper forming mold,
a transfer chamber comprising a transfer upper forming mold provided with suction enabling the glass to be held against it by the second principal face,
a bending suction lower mold able to bend the glass by suction on its first principal face,
the gravity support being mobile laterally and able to be positioned under the separation upper forming mold, the gravity support and the separation upper forming mold being able to be moved toward one another or away from one another so that the separation upper forming mold is adapted to take charge of the glass and offload the glass from the gravity support,
the suction lower mold being mobile laterally and able to enter the separation chamber, to be positioned under the separation upper forming mold, the suction lower mold and the separation upper forming mold being able to be moved toward one another or away from one another so that the separation upper forming mold is adapted to release the glass and press it the glass onto the suction lower mold and then be moved away from the latter,
the suction lower mold being able to exit the separation chamber loaded with the glass and to enter the transfer chamber and be positioned under the transfer upper forming mold,
the suction lower mold and the transfer upper forming mold being able to be moved toward one another or away from one another so that the transfer upper forming mold is adapted to take charge of the glass and offload the glass from the suction lower mold and then be moved away from the latter, the cooling specific support being mobile laterally and able to enter or exit the transfer chamber and to be positioned under the transfer upper forming mold or to be moved away from that position, the cooling specific support and the transfer upper forming mold being able to be moved toward one another or away from one another so that the transfer upper forming mold is adapted to release the glass onto the cooling specific support.

30. The device as claimed in claim 26, further comprising a cooling chamber, the cooling specific support loaded with the glass being able to enter the cooling chamber and to exit the cooling chamber offloaded of the glass, an offloading support able to support the glass without contact with the peripheral zone of the first principal face, being able to rise to take charge of the glass and offload the glass from the cooling specific support and to exit the cooling chamber loaded with the glass.

31. The device as claimed in claim 30, wherein the offloading support and the cooling specific support both comprise support elements comprising contact zones all of which come into contact with the glass exclusively in a contact band substantially parallel to the edge of the glass at most 150 mm wide, contact zones of the offloading support and of the cooling specific support being at least in part interleaved in the contact band at the moment of the transfer of the glass from the cooling specific support to the offloading support.

32. The device as claimed in claim 30, wherein seen from above and in orthogonal projection in a horizontal plane, at the moment of the transfer of the glass from the cooling specific support to the offloading support, at least one support element of the cooling support intersects the straight line tangential to exterior edges of two contact zones of adjacent support elements of the offloading support, the intersection occurring between two adjacent support elements of the offloading support.

33. The device as claimed in claim 26, wherein a train of gravity supports each of which is adapted to be loaded with glass is able to circulate under the separation upper forming mold, the latter being able to take charge of the glass from each of the gravity supports one after the other.
